(19) United States
(12) Patent Application Publication
(10) Pub. No.: US 2006/0015291 A1
(43) Pub. Date: Jan. 19, 2006

(54) Methods and systems for data analysis

(75) Inventors: David R. Parks, San Francisco, CA (US); Wayne A. Moore, San Francisco, CA (US)

Correspondence Address: QUINE INTELLECTUAL PROPERTY LAW GROUP, P.C., P O BOX 458, ALAMEDA, CA, 94501, US

(73) Assignee: Leland Stanford Junior University, Palo Alto, CA (US)

(21) Appl. No.: 11/157,468

(22) Filed: Jun. 20, 2005

Related U.S. Application Data
(63) Continuation-in-part of application No. 10/688,868, filed on Oct. 17, 2003, now Pat. No. 6,954,722.
(60) Provisional application No. 60/419,458, filed on Oct. 18, 2002.

(51) Int. Cl. G06F 19/00; G06F 17/18

(52) U.S. Cl. 702/179

(57) ABSTRACT

The present invention provides methods of analyzing and/or displaying data. In one aspect, the invention provides methods for visualizing or displaying high dynamic range data obtained from flow cytometry analyses. Related systems and computer programs products are also provided.

### CROSS-REFERENCES TO RELATED APPLICATIONS

This application is a continuation-in-part of U.S. application Ser. No. 10/688,868, filed Oct. 17, 2003, which claims the benefit of U.S. Provisional Application No. 60/419,458, filed Oct. 18, 2002, which are both incorporated by reference.

### STATEMENT AS TO RIGHTS TO INVENTIONS MADE UNDER FEDERALLY SPONSORED RESEARCH AND DEVELOPMENT

this invention was made with Government support under grant No. EB00231 awarded by the National Institutes of Health (Bioengineering grant, Leonard A. Herzenberg, PI.) The Government has certain rights to this invention.

### COPYRIGHT NOTIFICATION

Pursuant to 37 C.F.R. 1.71(e), applicants note that a portion of this disclosure contains material that is subject to and for which is claimed copyright protection, such as, but not limited to, source code listings, screen shots, user interfaces, or user instructions, or any other aspects of this submission for which copyright protection is or may be available in any jurisdiction. The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### BACKGROUND OF THE INVENTION

Flow cytometers are typically used to analyze the properties of single cells. For example, as a single cell suspension interrupts a laser beam of the flow cytometry system at high velocity, it produces a scattering of light from the beam. Data is generally relayed to a computer for interpretation of the results. These systems are typically designed for the enumeration, identification, and sorting of cells possessing selected properties. Fluorescence-activated cell sorting (FACS) is a specific type of flow cytometry, which utilizes fluorescent markers (e.g., fluorochrome-labeled monoclonal antibodies) to label cells in order to detect and sort the cells as part of multi-parameter analyses.

Flow cytometry fluorescence measurement data is currently displayed using either logarithmic or linear scaling. In most applications linear scaling fails to provide appropriate resolution across the typical data range of up to 10,000:1. Logarithmic displays are unable to deal with negative data values and typically introduce biologically artifactual peaks, particularly in data derived through fluorescence compensation. The result is that both the compactness and central tendency of low signal cell populations is severely obscured. Previous attempts to develop improved visualizations (e.g., displaying cytometry data for a human viewer) have not been very successful in that they have involved seriously compromising quantitation and/or introduced their own artifacts into the display (e.g., a simple linear-to-log splice tends to introduce a distinct transition line into the display).

To further illustrate, practical experience has demonstrated that marker distributions measured by flow cytometry are often more-or-less log-normal or are composed of mixtures of log-normal distributions. Logarithmic data scales, which show log-normal distributions as symmetrical peaks, are widely used and accepted as facilitating analysis of fluorescence measurements in biological systems.

On the other hand, cell populations with low mean, high variance and approximately normally-distributed fluorescence values occur commonly in various kinds of flow cytometry data. In particular, data values for cell populations that are essentially unstained or are negative for a particular dye after fluorescence compensation should be distributed more-or-less normally around a low value representing the autofluorescence of the cells in that data dimension. Data sets resulting from computed compensation commonly (and properly) include populations whose distributions extend below zero. (When analog compensation is used, such distributions should also appear, but the electronic implementations distort and/or truncate the distributions so that negative values are suppressed.)

Logarithmic displays, however, cannot accommodate zero or negative values and often show a peak above the actual mean of the population with a pileup of events on the baseline (as illustrated in, e.g., FIGS. 31A and B, 32, 33 and 34). This effect has been the source of considerable confusion and has been commonly referred to as the “log artifact”. Linear scaling is more appropriate and more easily interpreted for display of fluorescence compensated data on cell populations that are low to negative for a particular dye.

Thus, there is a need for display scales that combine the desirable attributes of the log scale for large real signals with those of the linear scale for unstained and near background signals. The methods described herein solve these problems, e.g., by plotting data on axes that are asymptotically linear in the region around data value zero and asymptotically logarithmic at higher (positive and negative) values.

Multicolor Fluorescence and Compensation

In a flow cytometer each fluorescence detector accepts light from a particular laser excitation and in a particular range of emission wavelengths optimized to detect a particular dye. However, every dye whose excitation is non-zero at that laser warelength and whose emission is not zero in the detector's emission band will contribute signal on that detector. Therefore, although fluorescent dye combinations used in flow cytometry are selected to minimize spectral overlaps, in multicolor measurements each dye will typically contribute signal on several detectors, and each detector will receive some signal from several dyes.

For each cell in a biological analysis, it is generally desirable to separate the signal contributions from the different dyes, so that an estimate of the amount of each fluorescent reagent is obtained. The process of converting from fluorescence color measurements to dye estimates is commonly called fluorescence compensation. By evaluating the response of each of the detectors to a series of compensation control samples each of which is labeled with only one dye a matrix of relative spectral overlaps can be constructed. For each cell, the set of detector color measurements is multiplied by the inverse of the spectral overlap matrix to obtain the corresponding set of dye estimates for the cell. This calculation is based on simple linear algebra, so any particular set of color measurement values yields a specific set of dye estimates. The estimated dye amounts are exactly those whose total signal on each detector would yield the color measurements actually observed.

Statistical Uncertainties in Dye Estimates

As is so often the case, this mathematical analysis is not complete in the real world. The fundamental deviation comes from the quantum nature of light and the finite amount of light detected. Thus, the detected signal is subject to what are commonly called counting statistics, governed by the Poisson distribution. In practice the limiting step is the number of photoelectrons emitted at the cathode of the photomultiplier tube. The standard deviation of actual measurements in relation to their theoretical expectation scales approximately with the square root of the number of photoelectrons detected.

For cells with just autofluorescence or very low dye levels the effects of photon statistics, possible electronic noise and real differences in low-level fluorescence among cells in a particular population often result in signal distributions with low means and high relative variances.

When raw color signals are compensated to obtain dye estimates, the statistical uncertainties are typically have an impact. For a computed signal derived from several inputs each of which has photoelectron count variance, these variances combine additively even when inputs are subtracted such as fluorescence spectral overlap or background light, essentially because the variance is a sum of squares and thus always positive. For cell populations that are unstained or low for a given dye but subject to spectral overlap from other dyes, the variance in the dye estimate is dominated by the Poisson variance of the total photoelectron signal (from all dyes) on the detector while the net estimate for the dye of interest results from subtracting estimated signals from all the other dyes. This can readily lead to standard deviations of the dye estimate greater than the mean for that estimate.

The end result is generally that dye estimates for cells that are unstained by a given dye have distributions that are nearly normal and centered near zero and may have large variances compared to the corresponding distributions for totally unstained cells. In particular, this process can properly result in negative dye estimates for some cells even though, of course, negative dye amounts are not possible. This occurs because of the subtraction of a relatively large value (the spectral overlap signal) with its associated relatively large error term, results in a dye estimate that is near zero, but still carries the same large error term: the plus-or-minus range of this error in the measurement can be significantly larger than the autofluorescence. The result is that the distribution of the negative cells can range from well above autofluorescence to well below autofluorescence, including some below “zero” fluorescence. In no case, however, can the mean of a population fall below zero except through instrument or experimenter error. These negative values must not be disregarded since truncating them will deform the data distributions and result in incorrect computation of signal means.

The overall result is generally that cell samples measured by flow cytometry often contain cell populations whose signal distributions are appropriately represented in logarithmic displays along with populations whose distributions cannot be properly shown in a logarithmic display. In certain aspect, the functions, methods, software, and systems described herein provide unified displays in which these different populations can all be represented in a clear and intuitive ways. These and other attributes of the present invention will be apparent upon complete review of the following.

### SUMMARY OF THE INVENTION

The present invention provides, e.g., improved analytical methods and/or displays for flow cytometry data and other (e.g., multidimensional) data types to promote correct and accurate interpretation of the information contained therein. Related systems and computer program products are also described herein.

In certain aspects, for example, the invention relates to data visualization methods that provide advantages over linear or logarithmic scaling for display of flow cytometry and other types of data. These methods scale the axes on one-dimensional histograms and bivariate plots to provide complete and readily interpretable displays of data from all cell populations, including those that have minimal fluorescence values and are poorly represented with traditional logarithmic axes. This “Logicle” scaling provides superior representations of compensated data and makes correctly compensated data look correct. It eliminates “picket fencing” and anomalous peaks introduced by log scaling. It also makes flow cytometry or other types of data more suitable for automated cluster analysis.

In certain embodiments, Logicle functions represent a particular generalization of the hyperbolic sin e function (sin h(x)=(e^{x}−e^{-x})/2) in which a general biexponential function is constrained in ways that are appropriate for plotting cytometric data. In some embodiments, Logicle functions have one more adjustable parameter than linear or logarithmic functions but not as many as a fully general biexponential. To obtain an optimized display for a particular data set, a Logicle function is typically chosen that provides sufficient linearization to suppress the kind of artifacts that appear in log scale displays of low signal cell populations while retaining near-log displays at higher signal levels. As also described herein, methods have also been developed for selecting an appropriate Logicle scale automatically.

The Logicle display methods of the invention generally provide more complete, appropriate and readily interpretable representations of data that include populations with low-to-zero means, including distributions resulting from fluorescence compensation procedures, than can be produced using either logarithmic or linear displays. In some embodiments, the methods described herein include a specific algorithm for evaluating actual data distributions and deriving parameters of the Logicle scaling function appropriate for optimal display of that data. Moreover, Logicle visualization generally neither changes the data values nor descriptive statistics computed from them.

In one aspect, the invention relates to a method of analyzing data. The method includes scaling raw data (e.g., high dynamic range data or the like) using at least one scaling function that provides substantially linear transformations for data values proximal to zero and substantially logarithmic transformations for other data values to generate scaled data. In certain embodiments, the raw data is derived through fluorescence compensation. The method also includes using the scaled data to identify portions of the raw data of interest. This aspect of the invention is further illustrated in FIG. 1. Typically, the scaling and/or the using comprise using a computer.

In some embodiments, the scaling comprises specifying at least one preliminary parameter such that other variables are constrained by one or more criteria of the scaling function to define at least one single variable transformation (e.g., a family of related transformations, etc.). Typically, a transition from linear to logarithmic scaling in the scaled data is substantially smooth (i.e., not including a distinct transition line).

Various other criteria also typically describe the scaling functions of the invention. In some embodiments, for example, the scaling function transforms negative raw data values. Typically, the second derivative of the scaling function is zero for a corresponding raw data value of zero. The scaling function is generally substantially symmetrical proximal to a raw data value of zero. In addition, the scaling function typically comprises one or more optimization functions for viewing different raw data sets.

In certain embodiments of the method, using comprises displaying the scaled data for a human viewer. For example, the scaled data is typically displayed on a coordinate grid and the scaling function primarily depends on data in a single data dimension to assure that the coordinate grid is substantially rectilinear. Display values generally increase in size more than corresponding display variables in linear regions of the scaled data as a family-generating variable is adjusted to increase a range of linearity. The scaling function typically includes at least one generalized hyperbolic sin e function. In some embodiments, the generalized hyperbolic sin e function is in a form of V=Z(10^{n/m}−1−G²(10^{-n/mG}−1)), where V is a data value to be displayed at channel position n in a plot of said scaled data, m is the asymptotic channels per decade, and G is linearization strength. In certain embodiments, the generalized hyperbolic sin e function is a form of V=a(e^{x}−p²e^{-px}+p²−1), where V is a data value to be plotted at display position x in a plot, a is a scaling factor, and p is linearization strength. Optionally, the generalized hyperbolic sin e function is a form of S(x; a, b, c, d, So)=ae^{bx}−ce^{-dx}−So, for positive x and for negative x, a reflection of the positive x in a form of Sref(x; a, b, c, d, So)=(x/absx) S(absx; a, b, c, d, So), where absx is the absolute value of variable x. In some embodiments, using comprises inputting said scaled data into at least one data analysis algorithm (e.g., automated data analysis software, such as cluster analysis software and the like) to identify the portions of the raw data of interest.

In another aspect, the present invention relates to a computer program product that includes a computer readable medium having one or more logic instructions for scaling raw data using at least one scaling function that provides substantially linear transformations for data values proximal to zero and substantially logarithmic transformations for other data values to generate scaled data. The computer readable medium typically includes one or more of, e.g., a CD-ROM, a floppy disk, a tape, a flash memory device or component, a system memory device or component, a hard drive, a data signal embodied in a carrier wave, or the like.

In still another aspect, the invention provides a system for analyzing data. The system includes (a) at least one detector, and (b) at least one computer operably connected to the detector, which computer has system software. The system software includes one or more logic instructions for receiving raw data from the detector in the computer, and scaling the raw data using at least one scaling function that provides substantially linear transformations for data values proximal to zero and substantially logarithmic transformations for other data values to generate scaled data. In certain embodiments, the system software further includes one or more logic instructions for displaying the scaled data for a human viewer. In some embodiments, the system software further comprises one or more logic instructions for analyzing the scaled data to identify portions of the raw data of interest (e.g., automated data analysis software, such as cluster analysis software or the like).

In some embodiments, analysis according to the invention can be accessed using an information processing system and/or over a communications network. According to specific embodiments of the invention, a client system is provided with a set of interfaces that allow a user to indicate one or more analyses and/or analysis parameters and that may direct a user to input the necessary initial data or option selections. The client system displays information that identifies analysis available and displays an indication of an action that a user is to perform to request an analysis. In response to a user input, the client system sends to a server system the necessary information. The server system uses the request data, and optionally one or more sets of server data, to perform the requested analysis. Subsequently, results data are transmitted to the client system. In specific embodiments, such analysis can be provided over the Internet, optionally using Internet media protocols and formats, such as HTTP, RTTP, XML, HTML, dHTML, VRML, as well as image, audio, or video formats, etc. However, using the teachings provided herein, it will be understood by those of skill in the art that the methods and apparatus of the present invention could be advantageously used in other related situations where users access content over a communication channel, such as modem access systems, institution network systems, wireless systems, etc. Thus, the present invention is involved with a number of unique methods and/or systems that can be used together or independently to provide analysis related to biologic or other data. In specific embodiments, the present invention can be understood as involving new business methods related to providing such analysis.

The invention and various specific aspects and embodiments will be better understood with reference to the following drawings and detailed descriptions. In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. For purposes of clarity, this discussion refers to devices, methods, and concepts in terms of specific examples, e.g., flow cytometry. However, the invention and aspects thereof have applications to a variety of types of devices and systems. It is therefore intended that the invention not be limited except as provided in the attached claims.

It is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems and/or methods that include many different innovative components and innovative combinations of innovative components and known components. No inference should be taken to limit the invention to combinations containing all of the innovative components listed in any illustrative embodiment in this specification. The functional aspects of the invention that are implemented on a computer, as will be understood from the teachings herein, may be implemented or accomplished using any appropriate implementation environment or programming language, such as C, C++, Cobol, Pascal, Fortran, Java, Java-script, PLI, LISP, HTML, XML, dHTML, assembly or machine code programming, etc. All references, publications, patents, and patent applications cited herein are hereby incorporated by reference in their entirety for all purposes. All documents, data, and other written or otherwise available material described or referred to herein, are incorporated by reference.

### BRIEF DESCRIPTION OF THE DRAWINGS

FIG. 1 is a flow chart illustrating a method of analyzing data according to specific embodiments of the invention.

FIGS. 2A-C show FACS data for mouse spleen cells stained with FITC-conjugated anti-B220.

FIGS. 3A-D show expected logicle plots for cells that are properly compensated, overcompensated, undercompensated or autofluorescent.

FIGS. 4A-C show data plots for wide range linear data.

FIGS. 5A-D show log and logicle data displays of a compensated single stain control.

FIGS. 6A and B show log and logicle displays of data with high variance and many negatives.

FIGS. 7A-D show log and logicle displays of data with moderate numbers of negatives.

FIGS. 8A-D show log and logicle displays of data with about 11% negatives.

FIG. 9 shows a display screen according to one embodiment of the present invention.

FIG. 10 shows a display screen that depicts a comparison of logarithmic scaling (“FlowJo” label) with Logicle scales using different linearization widths “W” (the upper number below each Logicle scale).

FIG. 11 shows plots of Logicle functions with different “p” values.

FIG. 12 shows plots illustrating Logicle functions in relation to linear and log asymptotes.

FIG. 13 is a plot that shows normal distributions displayed with different Logicle width parameters 1.

FIG. 14 is a plot that shows normal distributions displayed with different Logicle width parameters 2.

FIGS. 15A-F are plots showing multicolor cell data.

FIGS. 16A-D are plots showing a single set of test particle data with different linearization strengths.

FIG. 17 is a display screen of a program window and a scale illustration according to one embodiment of the invention.

FIG. 18 is a display screen of a program window and a scale illustration according to one embodiment of the invention.

FIG. 19 is a display screen of a program window and a scale illustration according to one embodiment of the invention.

FIG. 20 is a display screen of a program window and a scale illustration according to one embodiment of the invention.

FIG. 21 is a display screen of a program window and a scale illustration according to one embodiment of the invention.

FIG. 22 is a display screen of a program window and a scale illustration according to one embodiment of the invention.

FIG. 23 is a plot (Region −2 to 4) of a scaling function for different linearization strengths showing at what point in a display scale (horizontal) a particular data value (vertical) would be plotted.

FIG. 24 is a plot of a scaling function illustrated over narrower ranges (Region −2 to 3) than the plot depicted in FIG. 23 to show details of how the function behaves for different linearization strengths.

FIG. 25 is another plot of a scaling function illustrated over narrower ranges (Region −1 to 2) than the plot depicted in FIG. 23 to show details of how the function behaves for different linearization strengths.

FIG. 26 is another plot of a scaling function illustrated over narrower ranges (Region −1 to 1) than the plot depicted in FIG. 23 to show details of how the function behaves for different linearization strengths.

FIGS. 27A and B illustrate example interfaces for obtaining data analysis using a computer interface, possibly over a web page, according to specific embodiments of the present invention.

FIG. 28 is a block diagram showing a representative example logic device in which various aspects of the present invention may be embodied.

FIG. 29 is a block diagram illustrating an integrated system according to specific embodiments of the present invention.

FIG. 30 schematically illustrates the defining parameters for a Logicle display according to specific embodiments of the present invention.

FIGS. 31A and B are plots of log, linear and Logicle functions on log and linear scales, respectively.

FIG. 32 provides logarithmic and Logicle versions of histograms with similar variances but different means. Corresponding peaks in logarithmic and Logicle versions of histograms are plots of exactly the same data. The four distributions on a given plot have different means, but the same widths in real signal units.

FIG. 33 provides logarithmic and Logicle view plots that show that Logicle transformation retains low and negative data and provides more readily interpreted displays of low signal populations.

FIG. 34 includes plots of fluorescence data (uncompensated and compensated for Log visualization; compensated for Logicle visualization) showing improved display, avoiding misleading views, and visually confirming correct compensation in control sample data

FIG. 35 provides plots of cell data in logarithmic and Logicle display formats. As shown, the bi-exponential transformation makes compensated data more intuitive, as there are no events hidden on the axes and populations are visually identifiable.

FIG. 36 is a plot with a detailed comparison of Logicle and exponential-plus-linear display functions. The Logicle, log and linear curves in this plot are drawn from the same data shown in FIG. 31B, but only the “decade” range from 1 to 3 is shown rather than the full range of 0 to 4.5. This scale expansion allows the small differences between the Logicle and Exp+Lin curves to be seen clearly. Note that both the Logicle and Exp+Lin functions have the same slope as the linear line at “decades”=1 and that the Logicle curve stays somewhat closer to both the linear and log curves. The “Hyperlog display function” or “Hyperlog function” (discussed further below) is equivalent to the exponential-plus-linear formulation illustrated in this plot.

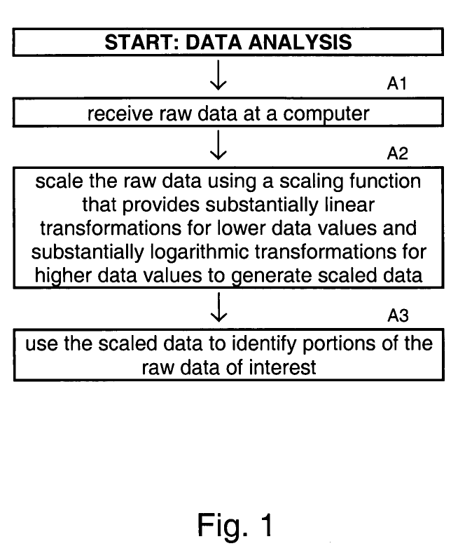

### DETAILED DISCUSSION OF THE INVENTION

Introduction

Before describing the present invention in detail, it is to be understood that this invention is not limited to particular methods, devices, or systems, which can, of course, vary. It is also to be understood that the terminology used herein is for the purpose of describing particular embodiments only, and is not intended to be limiting. In addition, unless defined otherwise, all technical and scientific terms used herein have the same meaning as commonly understood by one of ordinary skill in the art to which the invention pertains. Furthermore, it is to be understood that although the methods, systems, and other aspects of the invention are described herein, for purposes of clarity of illustration, with particular reference to flow cytometry, such reference is not intended to be limiting.

When flow cytometry data is properly compensated, it is common that a large number of cells are displayed crowded or poorly resolved proximal to a display axis. The cells typically become piled up in the first channel (against the axis) because the fluorescence parameters are displayed on a log scale where it is not possible to display “zero” or negative values. The spreading of a population into negative compensated data values is generally the result of statistical error in measurement that is inherent in the data collected on flow cytometers. Even though the measurement error is the same in uncompensated samples, the variation becomes obvious when a compensated population has a low mean and therefore appears in the low regions of the log scale. This is because log scales expand the view of data in the lower regions (first decade) and compress the view of data in the upper regions (fourth decade). The display transformations of the present invention provide data on an altered scale, e.g., that has a zero and a negative region. The data values are the same as before the transformation, because only the display is changed as described herein. For example, the display transformations of the present invention typically allow negative populations to be viewed as substantially symmetrical clusters instead of being poorly resolved near the display axis. Moreover, linear data can also be transformed as described herein to provide a more interpretable view instead of the “picket fences” that are frequently observed at the low end of 5+ decade log scales.

Regardless of the methods used to visualize the data and/or to delineate related groups of cells or other data events, the computations of statistics typically use the underlying best estimate data. This is not currently the case in some situations using pre-existing commercial flow cytometry software. In particular, very low and negative values may be truncated and computed as bottom of display scale values.

In evaluating possible scaling functions for displaying or visualizing data a set of criteria has been devised for the behavior of the scaling function and various parametrizations have been explored in order to fulfill the criteria. In particular, a set of criteria for a desirable transformation include, as follows:

1. The data scaling itself utilizes only single dimension data, and 2-D plots of such data will have straight, orthogonal grids of signal levels. Stated otherwise, the display function should depend only on data in a single data dimension, assuring that the coordinate grid is rectilinear. This assures that each data event is displayed at a position corresponding to its best estimate values, including negative values. (Note, that although this may seem like an obvious criterion, some pre-existing displays used in flow cytometry violate it due to electronic anomalies, and certain proposals have been made to devise transformations that will not plot as a rectilinear grid.).

2. The function becomes asymptotically logarithmic for high values of the display variable.

3. The function becomes linear proximal or near zero and extends to display negative values. Maximizing the near-linear range and making it symmetrical around zero signal level indicates that the second derivative of the function is zero at a zero data value.

4. The display formula supports a family of functions, which can be optimized for viewing different data sets.

5. The transition from linear to logarithmic behavior is substantially smooth, that is, does not have a distinct transition.

6. The reasonably linear zone grows in display value faster than in the display variable as the family variable is adjusted. For example, if the linearized zone were doubled in width in the plot it might cover four times the data range.

7. The function is substantially symmetrical around zero data value.

In some embodiments, a method for fulfilling these criteria and producing improved data displays is produced using generalized forms of the hyperbolic sin e function (sin h). This array of functions, their mathematical properties, specifications for using them to construct functions meeting the criteria stated above, and computational suggestions are described further below.

Once certain basic conditions, e.g., for the asymptotic scaling have been set, sufficient flexibililty is provided by having only one remaining variable to specify different versions of the family of display functions. Further, once preliminary parameters have been specified, the remaining variables are constrained by the criteria described above to define an effectively single variable transformation (i.e., a family of related transformations) which is suitable for automatic adjustment of the model parameter based on the set of data to be displayed in order to optimize, e.g., display or visualization.

The methods and other aspects of the present invention provide various advantages relative to many pre-existing approaches. To illustrate, the data scaling is specified by a mathematically well-defined function that can be readily computed. Also, variation in one parameter of the function creates a family of transformations whose members can be selected to optimize display of particular data sets. In addition, the linear to logarithmic transition is very smooth, minimizing the likelihood that display artifacts will be created. Further, the method retains a rectilinear display grid (lines of equal signal level are straight and horizontal or vertical). Moreover, for flow cytometry measurement data, the negative data values are produced as a result of computations in which population means should not be negative but the individual data points vary due to noise and statistical variations in the original data. In such a case, the data points with negative values should not form new populations or show structure beyond falloff of the statistical distribution with more negative values. This property is useful in testing for errors in the data or data computations or for improper choice of the display variable.

Other functional forms or ad hoc transformations that meet the criteria described above to provide displays that are improved relative to pre-existing displays are also contemplated.

Biexponential Functions

Mathematical Background

Consider the functions
s(x; a, b, c, d)=ae^{bx}−ce^{-dx}
c(x; a, b, c, d)=ae^{bx}+ce^{-dx}
where a, b, c, d>0. For example,
s(x; ½, 1, ½, 1)=sin h x
c(x; ½, 1, ½, 1)=cos h x
Notice that they are closed under arbitrary linear transformations of the argument, i.e.,
s(xy+z; a, b, c, d)=ae^{b(xy+z)}−ce^{-d(xy+z)}=s(x; ai^{bz}, by, ce^{-dz}, dy)
c(xy+z; a, b, c, d)=ai^{b(xy+z)}+ce^{-d(xy+z)}=c(x; ae^{bz}, by, ce^{-dz}, dy)
They have derivatives

$$\begin{matrix}\frac{ⅆ}{ⅆ x} s ( x ; a , b , c , d ) = ab {ⅇ}^{bx} + cd {ⅇ}^{- dx} = c ( x ; ab , b , cd , d ) \\ \frac{ⅆ}{ⅆ x} c ( x ; a , b , c , d ) = ab {ⅇ}^{bx} - cd {ⅇ}^{- dx} = s ( x ; ab , b , cd , d )\end{matrix}$$

and the sin h like functions have roots for

$$\begin{matrix}\frac{{ⅆ}^{2 n}}{ⅆ {x}^{2 n}} s ( {x}_{n} ; a , b , c , d ) = s ( {x}_{n} ; {ab}^{2 n} , b , {cd}^{2 n} , d ) = 0 \\ for {x}_{n} = \frac{ln c - ln a}{b + d} + 2 n \frac{ln d - ln b}{b + d}\end{matrix}$$

Usually b>d is desired so that the roots eventually become negative. We can take

$$w = - 2 \frac{ln d - ln b}{b + d}$$

as a dimensionless parameter and then
xₙ=x₀−nw.
By definition, x₀ is the point where the function s crosses zero and thus the point where the positive and negative exponential terms are equal. The point where the second derivative vanishes is x₁ and at that point the first derivative reaches its global minimum. Also, the functions are most nearly linear in the neighborhood of x₁.

To apply these ideas to data visualization the sin h⁻¹ like functions are exploited, which functions are essentially logarithmic for large arguments while also being nearly linear over a finite interval. Take x as the display coordinate and y as the data coordinate, then define a slightly more general set, the biexponential functions
B={β(x)=ae^{bx}−ce^{-dx}+f}
and their inverses
Λ={λ(y) where λ⁻¹(x)∈ B}
Since the functions β are continuous and monotonic the inverse functions λ are always well defined globally. Usually we will want a, b, c, d>0 but if we take the closure \overline{B}, i.e., weak inequality, we see that log_{b′}(y+c′)∈ \overline{Λ}. Therefore, the ordinary logarithm that is commonly used for data visualization and also the transform log(y+c), which has been proposed, are boundary points of B. Note that the inverse map B⇄Λ is bijective but \overline{Λ}→\overline{B} is surjective.

A data visualization transform must not depend on the location or scaling of the resulting graphic on the page or display. B is closed under such transformations. Conversely, for any λ(y)∈ Λ defined on an arbitrary display interval [x_{min,} xₘₐₓ] one can find values of the parameters that bring this data transform onto the interval [0, 1]. Therefore, without loss of generality, one may assume that this has been done once and for all. In these coordinates, the parameters depend only on the properties of the data transform and those properties are manifestly invariant under any linear viewing transform.

As stated there are five degrees of freedom in B. For flow cytometry one typically wants the linear region to be centered on data value y=0 so we require that β(x₁)=0 and β″(x₁)=0 by definition, fixing two of them. Therefore λ(0)=x₁, β′(x) is at its minimum while λ′(y) reaches a maximum, i.e., the display space per data unit is greatest in the neighborhood of zero. We call the remaining subset the “logicle” functions. Note that sin h⁻¹ ∈ Λ′ but log ∉Λ′.

We have seen that the choice of w fixes one degree of freedom. We have found it useful to keep yₘₐₓ the maximum data value fixed and located at the upper end of the display scale, i.e., yₘₐₓ=β(1). Finally, we define the dilation at a point D(y)=λ′(y)/λ′(yₘₐₓ), which measures the relative amount of display space given to a unit of data near that value. For example, for the logarithm D(y)∝ 1/y everywhere, which is an elaborate way of stating the well known scale invariance of logarithmic plots. The virtue of this approach is that in the case of the logicle functions it remains bounded and is well defined at the origin. In fact, the function is now fixed by the choice of D₀=D(0)=y′ₘₐₓ/y′ₘᵢₙ, the dilation in the neighborhood of zero. If we take a logarithmic scale with D_{log}=D(yₘᵢₙ)=yₘₐₓ/yₘᵢₙ, then a logicle scale with x₁=0 that matches the log scale for large values will have

$${D}_{0} < \frac{1}{1 + \frac{b}{d}} {D}_{log} and for {D}_{log} > 100 {D}_{0} \approx \frac{1}{1 + \frac{b}{d}} {D}_{log}$$

and for D_{log}>100 or when w is moderate even D_{log}>10. We see that a logicle scale will have at most half the dilation of the corresponding logarithmic scale. Increasing w will decrease D₀ as will increasing x₁ as long as we keep yₘₐₓ fixed.

Thus the parameters x₁, D₀ and w characterize the visually important features of the logicle transforms. Note that both the parameters and the logicle condition itself are independent of a change in data units or “gauge” transformation. Therefore all dimensional information is contained in yₘₐₓ. The logicle functions satisfy all the mathematical requirements for data visualization.

Choosing the Parameters from Data

Start with a distribution that is unimodal and crosses zero in some logicle scale. Increasing the dilation D₀ visually “splits” this distribution noticeably, which is undesirable. Generally we wish to decrease D₀, i.e., to reduce the display space given to relatively small absolute values. If the distribution is rescaled, i.e., the data values are all multiplied by some constant k, then if we choose D₀ ∝ 1/78 , features of this distribution remain fixed with respect to one another in display space. However, this is strictly true only at zero and in practice even this prescription falls behind for large multipliers. If we keep large data values unchanged and w=0 then increasing x₁ decreases D₀. This transformation is very similar in behavior to the European companding function but is continuous in the higher derivatives. Increasing w also decreases D₀ but not as quickly as increasing x₁ so the distribution will broaden somewhat in the display. As discussed below, we have found that utilizing these effects equally is an effective strategy and this broadening gives the user information on the strength of the effect.

We will estimate the scale k by measuring some feature y_{ref} from the distribution. Since we expect there may be more events in the tail than in a normal distribution, we take as the scale the fifth percentile of the negative data values. This seems to balance sensitivity to extremal events with reasonable sampling stability. We estimate k=y_{ref}/yₘᵢₙ (probably this should be k=2y_{ref}/yₘᵢₙ).

Then we want to choose w, x₁ and D₀ appropriately. We have found it useful to impose an additional constraint, which is reasonable for flow cytometry but is not required and might not be optimal for all applications. Since the width w of the nearly linear region will be set by the most negative values observed we will always choose x₂=0, i.e., this point will be the lowest visible point on the scale. This implies that x₁=w in display coordinates and that x₁ ∈|0, 1| so that this point will be “on scale”, i.e., visible to the user. Note that in the original implementation we don't use the transfer function directly in this region but rather its reflection in x₁ for symmetry. If the x₂=0 condition is always imposed, the difference is most likely negligible visually but if more negative values are included in the display, it will rapidly become important.

We have used two strategies for choosing the parameters. The preferred method is to fix
D_{log}=10^{4.5}
so that large data values are essentially fixed, which is desirable. Then we take

$$w = \frac{ln \sqrt{k}}{ln {D}_{log}} and that gives {D}_{0} \approx \frac{1}{1 + \frac{b}{d}} \frac{{D}_{log}}{\sqrt{k}}$$

and that gives consequently some distortion of the distribution at small absolute values, i.e., the nearly linear region occurs. If zero falls on the shoulder of the distribution, this can produce a spurious peak but otherwise, it should be visually innocuous. We arrived at the value 10^{4.5} empirically but in retrospect it appears the value D_{log}=2×10⁴ would be an appropriate choice for a “four decade” logicle scale.

We originally used
D_{log}=k10^{4.5}
This choice of D_{log} keeps only yₘₐₓ fixed, i.e., not large data values in general. Choosing

$$w = \frac{ln k}{ln {D}_{log}} gives {D}_{0} \approx \frac{1}{1 + \frac{b}{d}} {10}^{4.5}$$

gives Other than a simple resealing, this would keep the nearly linear region fixed in itself. However, the need for a higher value of w means increasing distortion in the logarithmic region and the scale is accurately logarithmic over a smaller range. For a given range of linearization, the previous method allows some distortion of the linear region but produces much less distortion of the logarithmic region.

The results will be suspect if w is so large that D₀<10, i.e., when the linear region reaches the upper most decade.

Computing Logicle Transforms

We start with a sample Yᵢ for i=1, . . . , n of data values. For flow cytometry these will be a linear combination of measured fluorescence emissions that is our best estimator of the amount of dye associated with a cell. We desire to convert this data to a chosen logicle scale so that Xᵢ=λ(Yᵢ). Using Newton's method we could solve β(Xᵢ)=Yᵢ with quadratic convergence at the cost of two exponential function evaluations per iteration. While binary search gives only linear convergence, it requires only two square root evaluations per iteration, which will be faster at lower resolutions. For data visualization we will usually use Xᵢ to choose a pixel coordinate or histogram bin and thus we are limited to a total number of distinct values m within an order of magnitude of 10³. If n>m then it will be fastest to tabulate the values of the function β in memory and if n>>m as is typical of flow cytometry it will be much faster.

For convenience, we will always work in the standard display coordinate system [0,1]. Therefore the practical problem is to find numerical values for the parameters a, b, c, d, f and then to compute β|j|=β(j/m) for n=0, . . . , m. We have chosen D_{log} by convention and thus b=ln D_{log}. Using a modified Newton's method (Numerical Recipes) we then solve

$$w = 2 \frac{ln b - ln d}{b + d}$$

for d, where w is chosen as described above. We then use the condition x₂=0 to compute

$$\frac{c}{a} = {ⅇ}^{2 w ( b + d )}$$

the condition λ(0)=x₁ to compute

$$\frac{- f}{a} = {ⅇ}^{bw} - \frac{c}{a} {ⅇ}^{- dw}$$

and finally the condition λ(yₘₐₓ)=1

$$\frac{{y}_{max}}{a} = {ⅇ}^{b} - \frac{c}{a} {ⅇ}^{- d} + \frac{f}{a}$$

and the value of yₘₐₓ to compute a. From these constants and two exponential function values we can then compute β[j]. When m is a power of 2 the recurrence

$${ⅇ}^{\frac{x + y}{2}} = \sqrt{{ⅇ}^{x} {ⅇ}^{y}}$$

provides an accurate and efficient method of computing the required exponentials.

Visualization of FACS Data: Logicle Axes

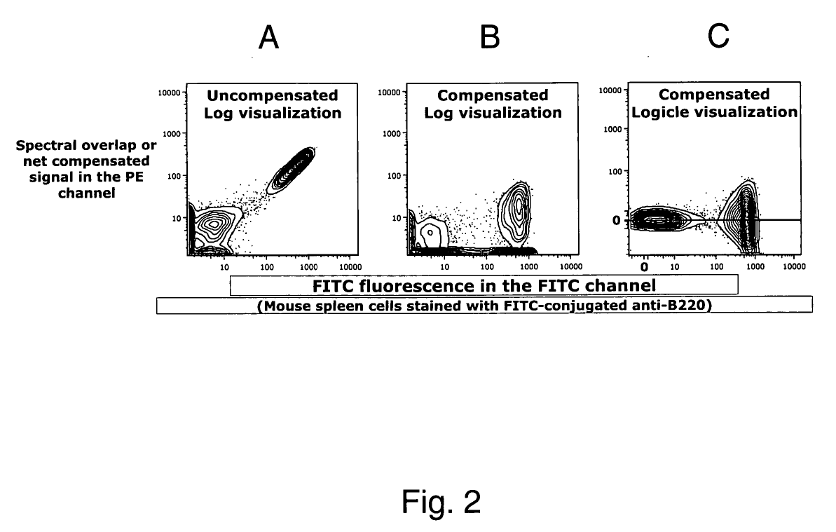

The pre-existing contour and dot plots that are used by most laboratories have standard four-decade logarithmic axes that provide a wide dynamic range for display of FACS data. However, the absence of a zero point and negative values on these logarithmic axes introduces major problems, particularly for visualizing cells with little or no associated fluorescence. This interferes with visualizing compensated data, since the subtraction of spectral overlap during compensation is designed to return cells with no associated fluorochrome to background values. Statistical variation in the number of photoelectrons detected typically results in “negative” cell populations with more spread in compensated data values than would be observed for the same set of cells completely unstained. In such circumstances some cells commonly receive negative data values that are simply part of the overall distribution for the population. If compensation values are appropriately set, compensated data values for a cell population that is negative for a particular dye can be expected to distribute symmetrically around a low value representing the autofluorescence of the cells in that dye dimension. Logarithmic displays, however, cannot accommodate zero or negative values. This situation can be understood as follows: on a logarithmic scale, all values below the lowest decade must either be discarded (not acceptable) or “piled up” at the lowest point on the scale. The pile-up obscures the true center of the compensated distribution. Furthermore, it often breaks the distribution artificially into what appears to be two subsets, one centered on the pile-up (the lowest point on the scale) and the other centered higher than the true center of the compensated population (see FITC-positive cells in FIG. 2, panel B). This data display artifact often results either in misinterpretation of the higher “population” as a weakly positive subset or in serious over-compensation of the entire data set due to attempting to force this “population” down to the axis.

The Logicle data display, described herein, addresses these problems by enabling visualization of FACS data on mathematically defined axes that are asymptotically linear in the region just above and below zero and asymptotically logarithmic at higher (positive and negative) values. Thus, compensated values that fall either above or below zero can be correctly displayed. Note that logicle visualization does not change the data. It merely allows lower data values to be properly represented and allows peaks in the region around zero to be located in their proper position.

FIG. 2 illustrates how the Logicle display makes it easy to confirm the accuracy of fluorescence compensation. This figure shows data for a cell sample stained only with an FITC reagent. This stain divides the cell sample into two subsets. One subset is not stained by the FITC reagent while the other has a high FITC signal with significant spectral overlap detected on the PE channel (FIG. 2, panel A). In a properly compensated sample involving only PE and FITC staining, the spectral overlap will be subtracted from the fluorescence collected on the PE channel and the signals for all populations on the PE channel will be distributed symmetrically around the autofluorescence value for the cells in the sample (FIG. 2, panel C). When multiple fluorochromes are involved, the compensation calculations are more complex, but the end result is the same: the spectral overlaps are corrected and the distribution representing cells that do not bind the fluorochrome detected in a given channel wind up in a peak centered on their mean autofluorescence value.

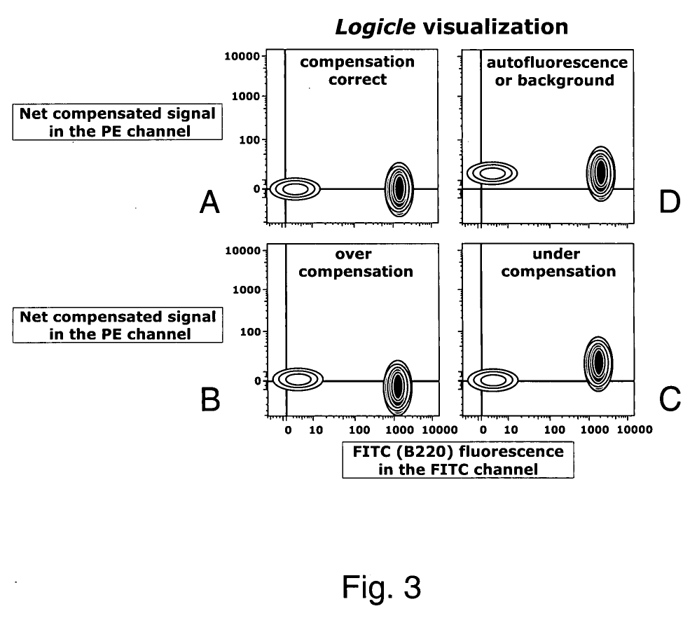

The diagram in FIG. 3 shows the expected logicle plots for cells that are properly compensated (panel A), overcompensated (panel B), undercompensated (panel C), or autofluorescent (panel D). Note that overcompensation drives the peak for the FITC-positive population below the mean autofluorescence in the PE channel while undercompensation fails to bring this population to equivalence with the FITC-negative population. For cells that are equally autofluorescent in the PE channel, both the FITC-positive and the FITC-negative cells will be distributed symmetrically around the mean PE channel autofluorescence value.

Further Description of the Logicle Methods

The display methods described herein reliably customize the display parameters to particular data. A working implementation is available on the world wide web at flowjo.com.

The methods described herein overcome many of the problems with log displays of data using matrix computed compensation. It has turned out that analog compensation as normally implemented not only tends to overcompensation and distorts data, but it also makes the overcompensated single stain control populations look much more compact than is possible from the statistical quality of the actual data. Thus, we have to explain both the comforting distortion of the analog compensated data and deal with visualizing the correct but more spread out computed compensation results.

As described herein, the Logicle scaling is a particular generalization of the hyperbolic sin e function (sin h(x)=(e^{x}−e^{-x})/2). The hyperbolic sin e is a good point of departure because it is close to linear around zero (second derivative equals 0 at 0 data value), allows negative values to be plotted, becomes essentially exponential for high data values and makes a very smooth transition between the linear and exponential regions. When this is used as a plotting function, data in the near linear zone gives a near linear display while data in the near exponential zone gives an effectively log display (a pure log display would be obtained by taking just e^{x} with scaling adjustments).

The hyperbolic sin e function in itself, however, does not provide sufficient adjustability to meet the needs for plotting compensated fluorescence data. Therefore, a generalized biexponential functions which add separate coefficients for each of the two exponential terms and for their exponents is typically utilized. The Logicle function constrains or limits the general biexponential in ways that are appropriate for plotting cytometric data. The biexponential coefficients vary but their relationships are linked so that the effective adjustments are in the range and steepness of the linear zone while the most linear zone stays centered at zero, etc. In this way the Logicle function has more adjustable variables than the hyperbolic sin e but not as many as a fully general biexponential.

The way Logicle displays are implemented in, e.g., FlowJo 4.3 (available on the world wide web at flowjo.com) is to examine the compensated data set used in defining the transformation to see how much range of linearization is needed in each compensated dye dimension. The specific method is to find the 5th percentile data value among the negative data in each dye dimension. This value is used to select the adjustable parameters in the Logicle function so that the resulting display will have just enough linearity to suppress the “log display artifact” of peaks not being at the actual center of data distributions and will show enough negative data range to bring almost everything on scale.

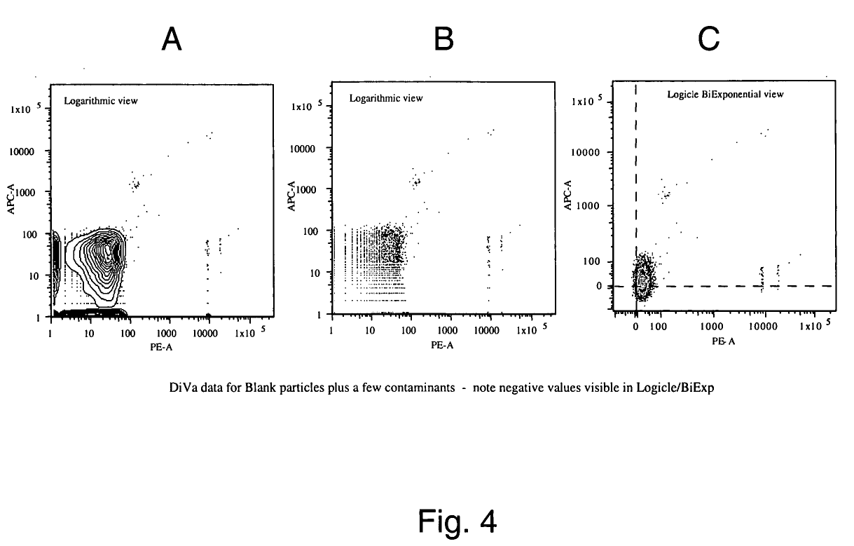

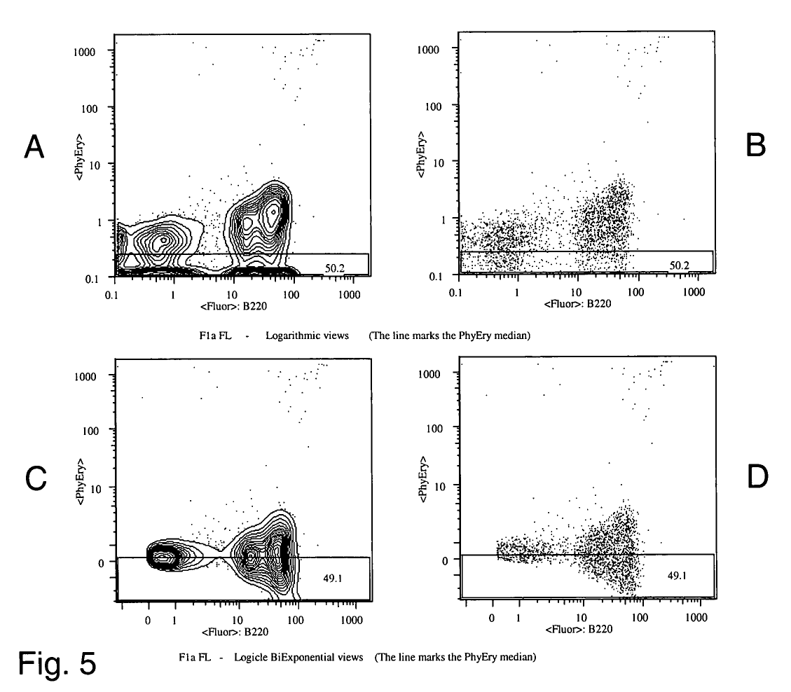

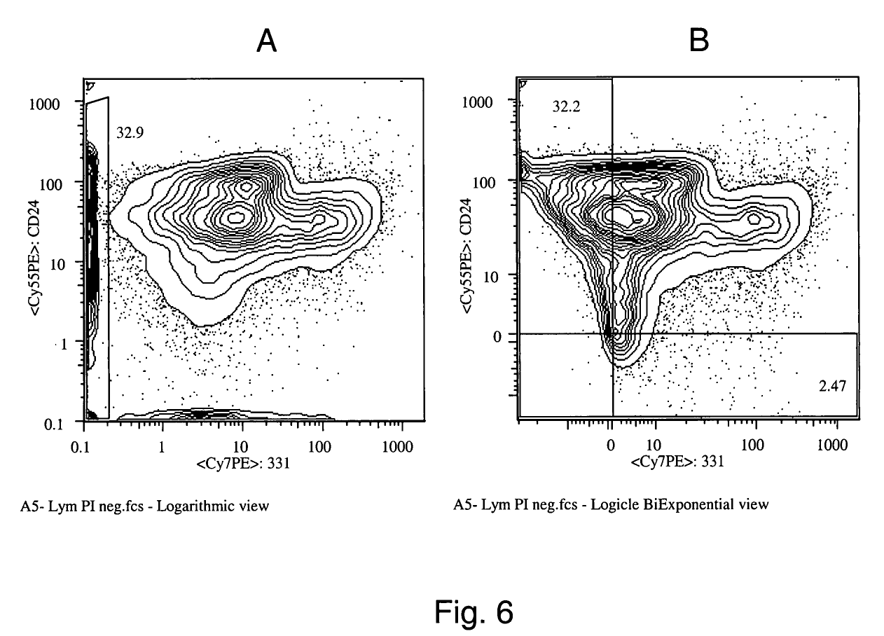

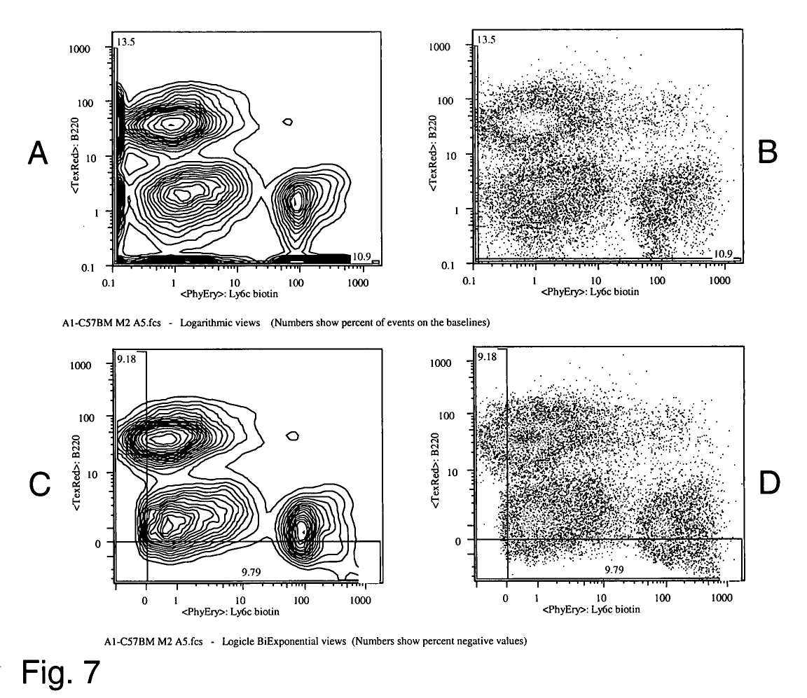

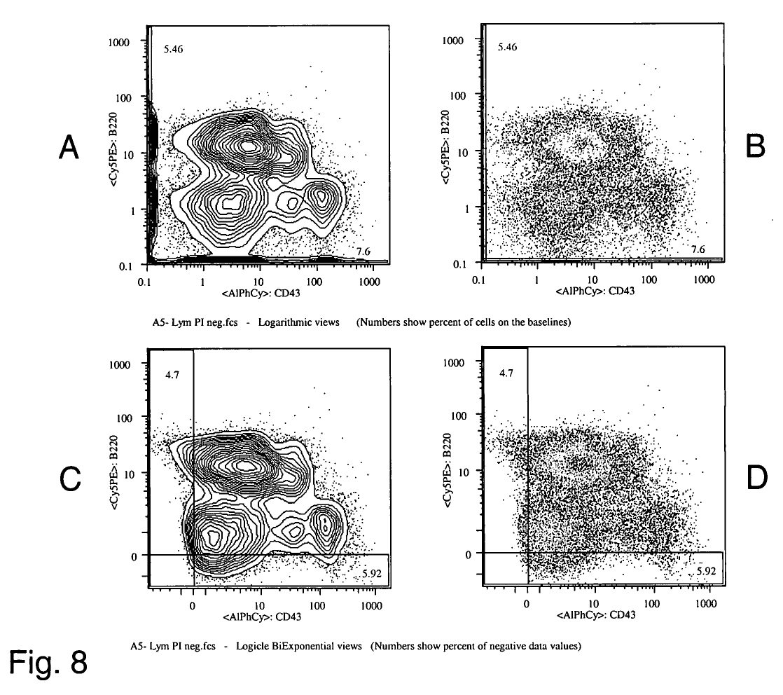

FIGS. 4-8 illustrate the results comparing log displays with Logicle displays of the same data. FIGS. 4A-C show plots blank bead data from the BD digital electronics with floating point export so that the “picket fence” effect is eliminated and even the negative area signals are properly represented. Note, the negative values visible in FIG. 4C. FIGS. 5A-D show single stain control data with a median line drawn in. The Logicle representation shows the matched centering but greater vertical dimension spread in the positive population. FIGS. 6A and B show very smeary, low photon red-red data in which the log view is quite deceptive. FIGS. 7A-D and FIGS. 8A-D show how the edge data populations in the log plots are really just ordinary parts of the adjacent populations.

The computed compensation on linear data is best if resolution is adequate. Computed compensation on uncompensated logamp data is good if log scaling is reasonably accurate. Analog compensation on all instruments tested leads to overcompensation and signal estimate distortion. Log display of computed compensation data cannot represent the full data range and promotes incorrect interpretations of cell populations. The Logicle-BiExponential display method of the invention does a much better job of representing multicolor FACS data in a way that facilitates correct interpretation and accurate delineation of cell populations.

Exemplary Function Constructed for Data Display

As described above, the function constructed for data display (e.g., FACS data display, etc.) starts with the sin h function:
sin h(x)=(e^{x}−e^{-x})/2
This can be generalized as a biexponential function:
v(x; a, b, c, d, k)=ae^{bx}−ce^{-dx}+k
The specifications and constraints (V and V″=0 at x=0) lead to:
V=a(e^{x}−p²e^{-px}+p²−1)
where V is the data value to be plotted at display position x in the plot, a is a scaling factor and p is the strength of the linearization. This is one embodiment of the “Logicle” function, referred to above.

One way to express the Logicle function for data value “V” is using two parameters, an overall scaling “a” and a linearization parameter “p”, and the display variable “x”. The linearization width “w”, referred to above, is w=2p*ln(p)/(p+1). The plain hyperbolic sin e function has p=1<=>w=0. For high values of p, w approaches 2ln(p).

In order to increase the range of data values in the relatively linear zone around zero, we can increase the overall scale factor “a” or increase “p” (increase “w”). In one implementation of certain aspects of the invention (Logicle 1.1 and FlowJo4.3 available on the world wide web at flowjo.com) the need for increased near-linear range is accommodated with a balanced increase in both the overall scaling and in “w”. For example, if we had a Logicle function with parameters a₁ and w₁ and wanted a new function to accommodate 4 times the data range in the relatively linear zone we would adjust each parameter to cover 2 times the range so that the total adjustment would be 2×2=4. This would lead to a2=2*a₁ and w₂=w₁+ln(2). This is functionally the same as described above using dilation D and w and x₁.

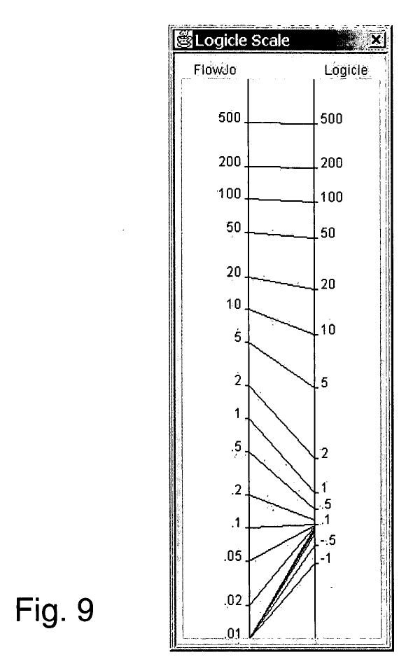

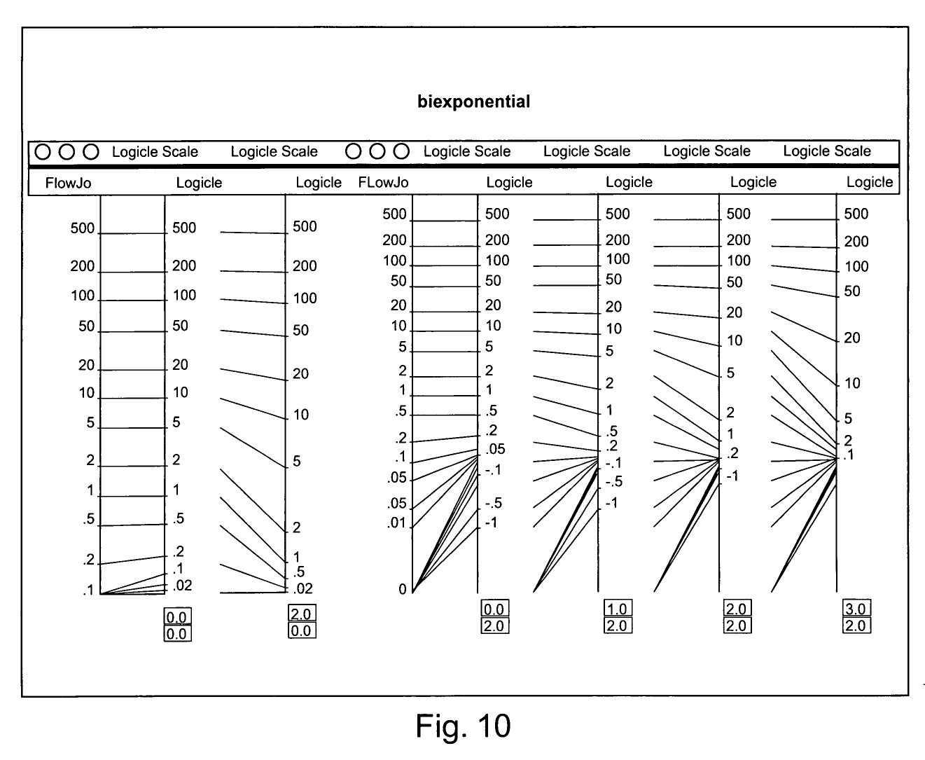

Aspects of the Logicle function are further illustrated in the figures. For example, FIG. 9 shows a display screen according to one embodiment of the present invention. Note, that depending one the choice of parameters the program can provide a range of behaviors with similar properties but this example exhibits the general features of the method and how it differs from an ordinary logarithmic scale. To further illustrate, FIG. 10 shows a display screen that depicts a comparison of logarithmic scaling (“FlowJo” label) with Logicle scales using different linearization widths “W” (the upper number below each Logicle scale). In particular, this is a composite version of six Logicle scales. There are two display variables below each Logicle scale. The upper one relates to the strength of the linearization. The lower one adjusts the amount of space on the scale allocated to negative data values so that, for a value of zero, the data zero is at the bottom of the scale and, for a value of 2, negative values get space corresponding to 2 decades in the upper logarithmic region.

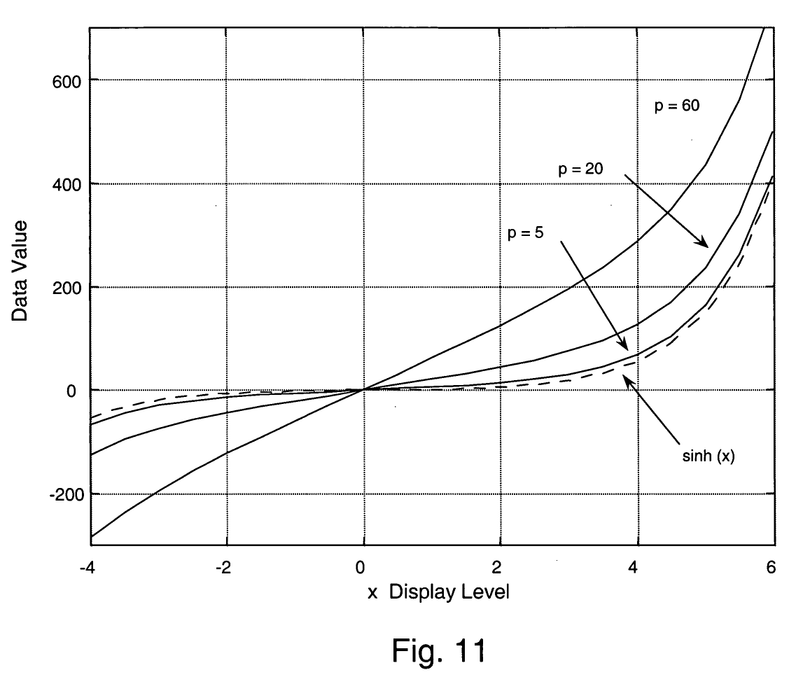

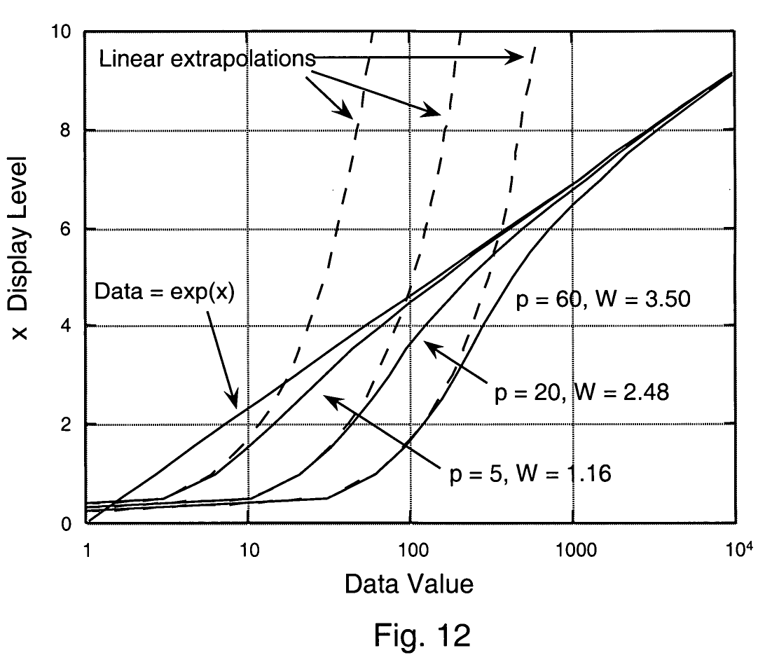

FIG. 11 shows plots of Logicle functions with different “p” values. Sin h(x) corresponds to p=0. FIG. 12 shows plots illustrating how Logicle functions stay close to corresponding pure linear functions (dashed lines) for low data values and move over to being close to pure log (data=exp(x)) for high data values. The “W” values shown in the figure are just base 10 versions of the “w” discussed above so that W=w/ln(10).

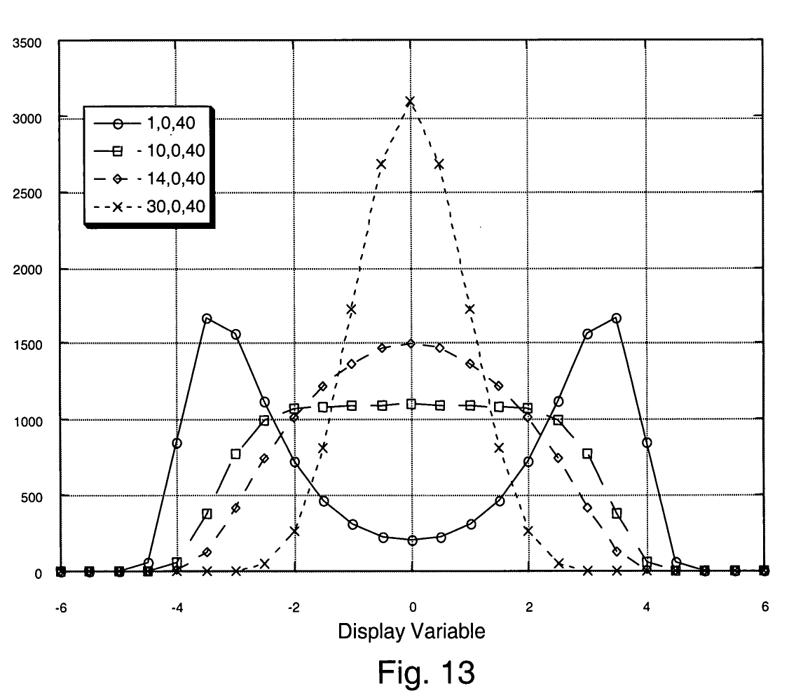

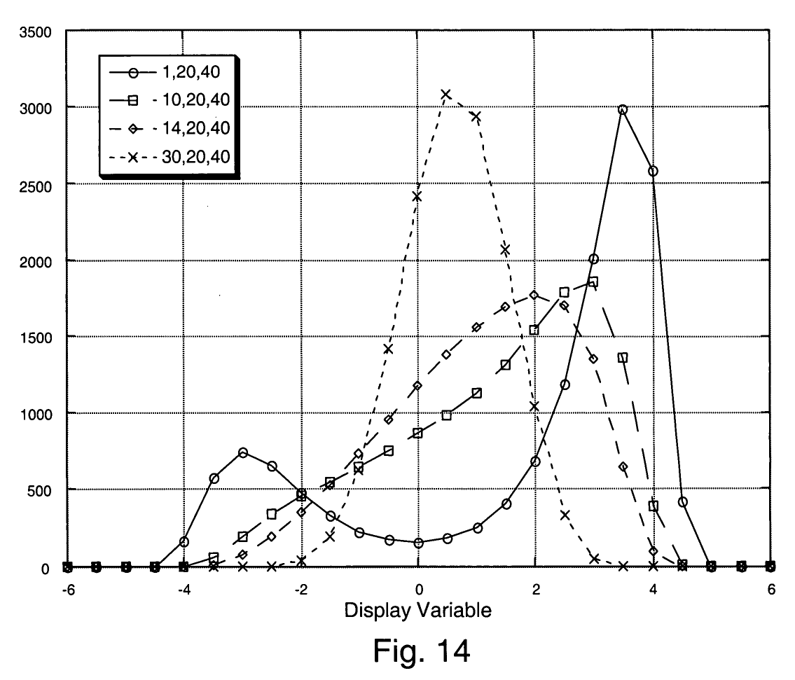

FIG. 13 is a plot that shows normal distribution with mean zero displayed with different Logical scalings. If “p” is too low (e.g. p=1) the display “breaks up” into two apparent peaks. This is the kind of display behavior that is typically to be avoided. For p=10 the display is flat topped but not bi-modal. For p=14 the display is clearly unimodal—this is approximately the minimum linearization that would be considered desirable. For p=30 the display is close to linear over the main part of the distribution, so the display looks visually like a normal distribution. FIG. 14 is the same plot as FIG. 13 except that the normal distribution has a mean of 20 rather than 0.

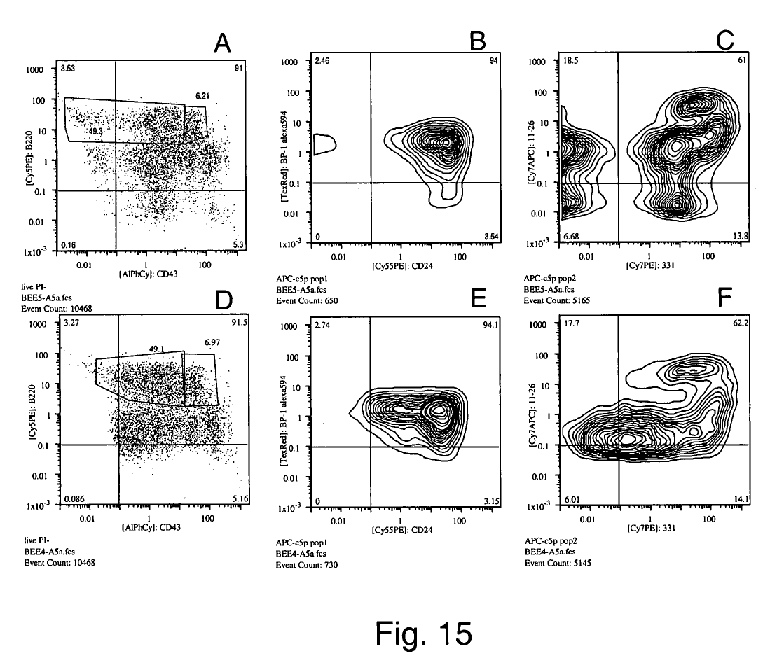

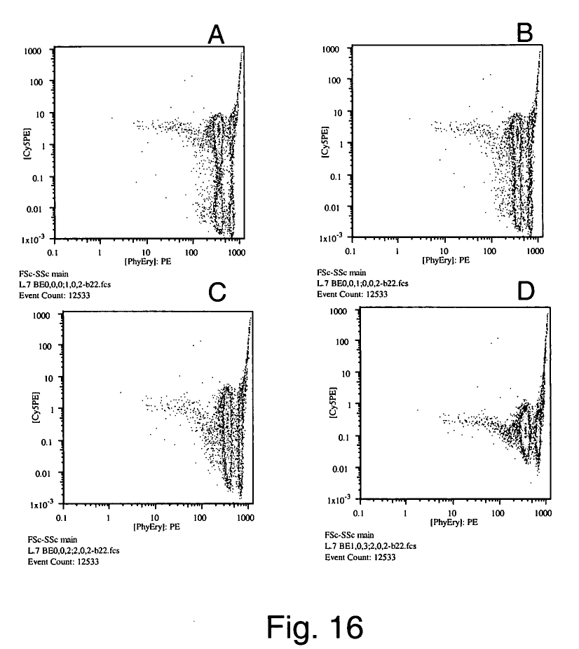

To further illustrate aspects of the invention, FIGS. 15A-F are plots showing multicolor cell data. The upper row (FIGS. 15A-C) show minimum linearization, and what is to the upper right of the crosshairs (which indicate the zeros in the two dimensions) is close to what would be seen in an ordinary log plot. The lower row (FIGS. 15D-F) show the same data displayed with stronger transformation as appropriate for the particular data dimensions. FIGS. 16A-D are plots showing a single set of test particle data with different linearization strengths (W=0, 1, 2 and 3) in the vertical dimension. The logarithmic scales shown in FIGS. 15 and 16 do not represent the actual Logicle scales used to generate the displays.

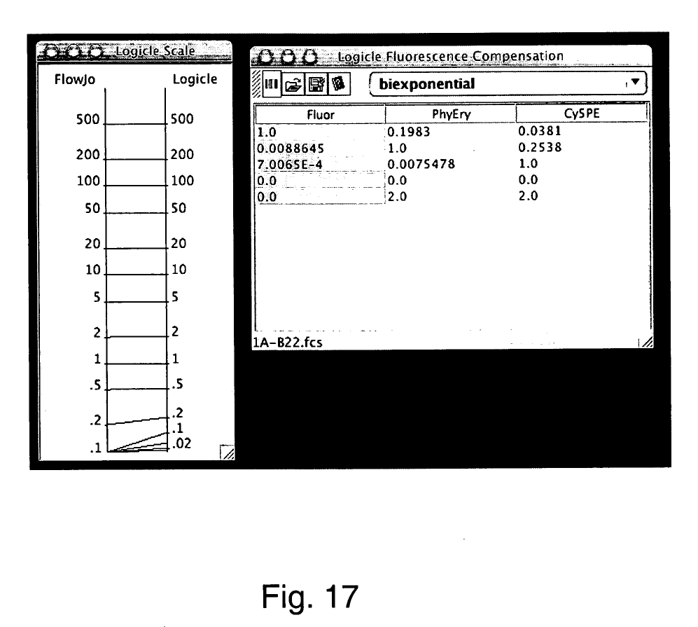

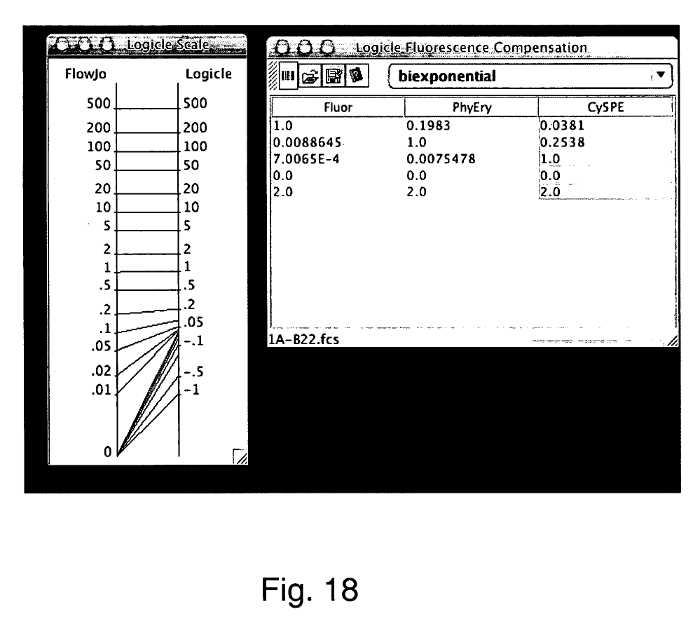

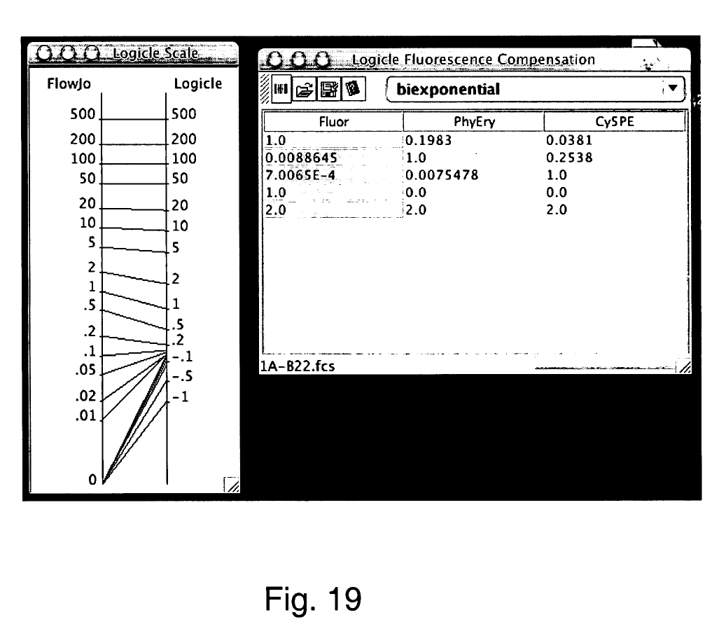

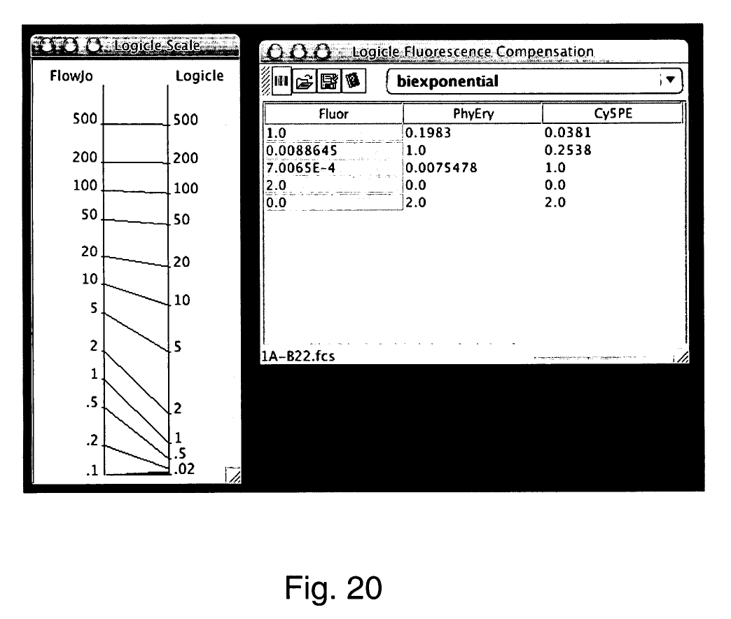

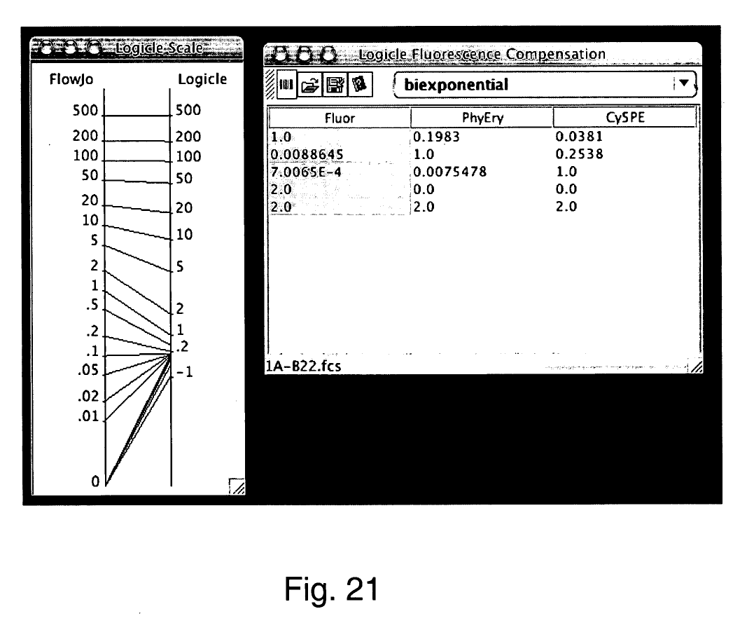

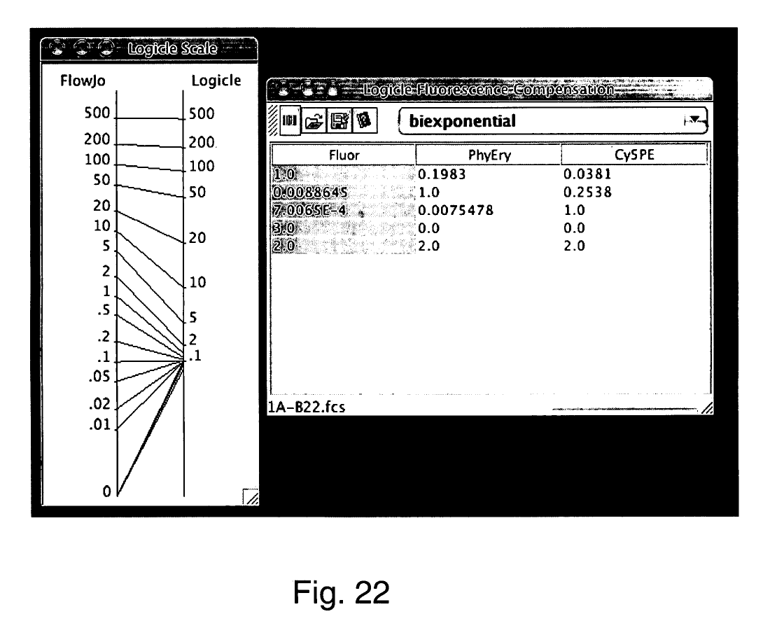

FIGS. 17-22 are display screens of program windows and scale illustrations. The right side scale in each nomogram is what would be the edge scale on a piece of graph paper used to plot the data. In FIG. 17, the strength of the linearization around zero is 0, and the number of “decades” of space added on the negative side is 0. In FIG. 18, the strength of the linearization around zero is 0, and the number of “decades” of space added on the negative side is 2. In FIG. 19, the strength of the linearization around zero is 1, and the number of “decades” of space added on the negative side is 2. In FIG. 20, the strength of the linearization around zero is 2, and the number of “decades” of space added on the negative side is 0. In FIG. 21, the strength of the linearization around zero is 2, and the number of “decades” of space added on the negative side is 2. In FIG. 22, the strength of the linearization around zero is 3, and the number of “decades” of space added on the negative side is 2.

Another Exemplary Function Constructed for Data Display

As above, the function constructed for data display (e.g., FACS data display, etc.) starts with the sin h function:
sin h(x)=(e^{x}−e^{-x})/2
This is generalized and expressed in base 10 as:
V=a(10^{bx})−c(10^{-dx})+k
The specifications and constraints (V and V″=0 at x=0) lead to:
V=Z(10^{n/m}−G²(10^{-n/mG}−1)
where V is the data value to be displayed at channel position n in the plot, m is the asymptotic channels per decade, and G is the strength of the linearization. Note, that this is a version of the function in terms used for display of flow cytometry data. The family of related functions is produced for different values of G.

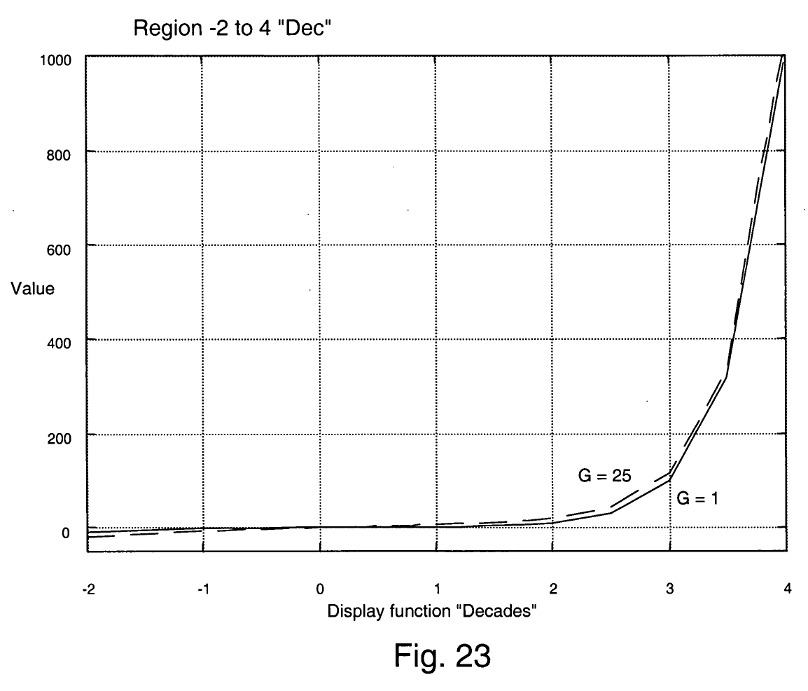

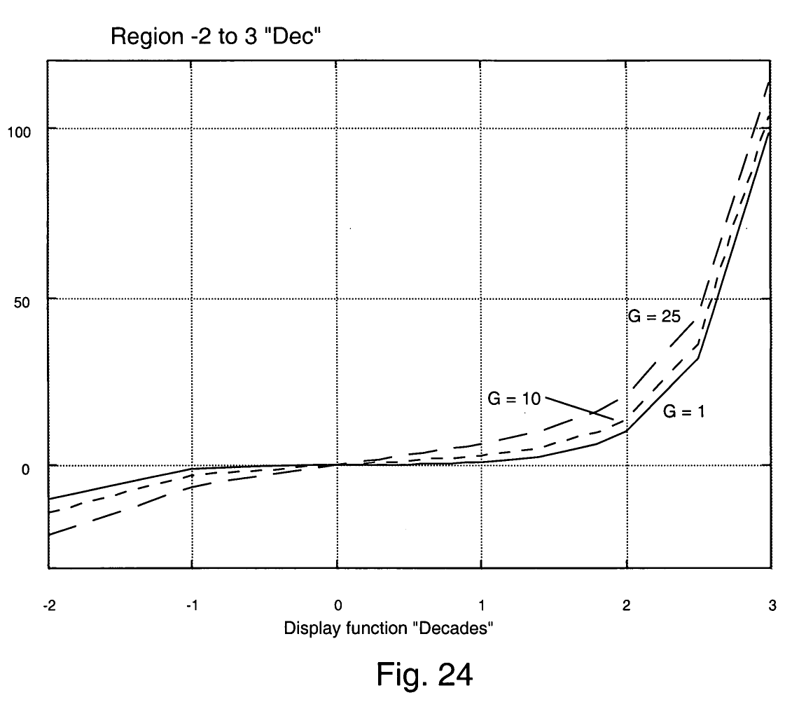

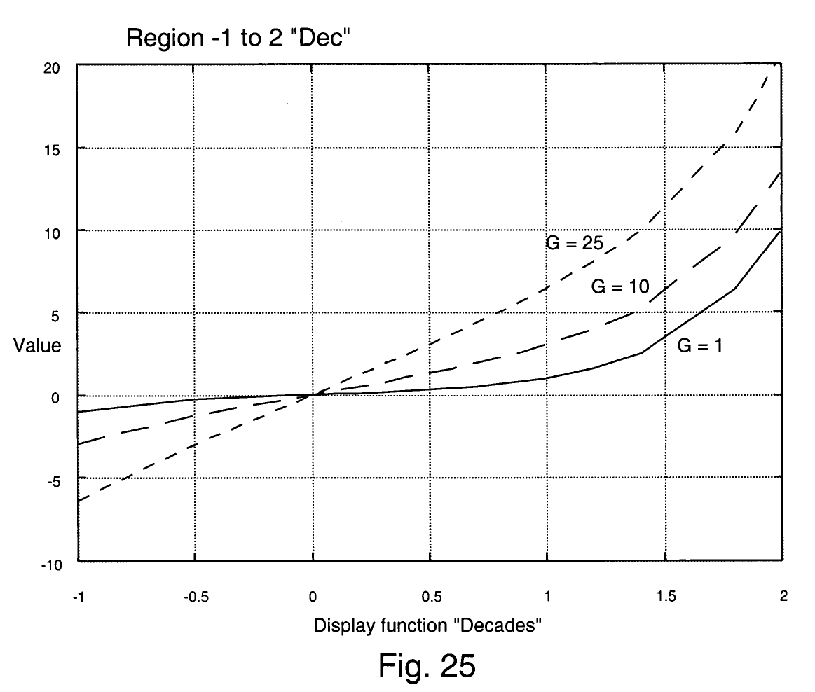

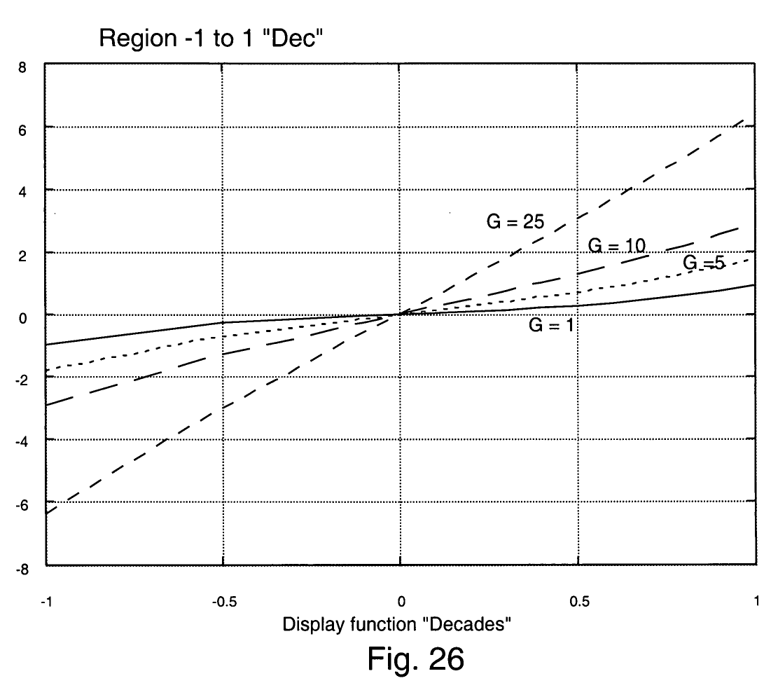

To further illustrate, FIG. 23 is a plot (Region −2 to 4) of a scaling function for different linearization strengths showing at what point in a display scale (horizontal) a particular data value (vertical) would be plotted. FIG. 24 is a plot of a scaling function illustrated over narrower ranges (Region −2 to 3) than the plot depicted in FIG. 23 to show details of how the function behaves for different linearization strengths. FIG. 25 is another plot of a scaling function illustrated over narrower ranges (Region −1 to 2) than the plot depicted in FIG. 23 to show details of how the function behaves for different linearization strengths. FIG. 26 is another plot of a scaling function illustrated over narrower ranges (Region −1 to 1) than the plot depicted in FIG. 23 to show details of how the function behaves for different linearization strengths.

### Additional Embodiments

### Exemplary Criteria for Certain Data Display Method Embodiments

Exemplary criteria for defining a scaling function that is better suited to display, e.g., flow cytometry data than traditional logarithmic or linear scaling are as follows:

The display formula supports a family of functions, which can be optimized for viewing different data sets.

The function becomes logarithmic for large data values to ensure a wide dynamic range and to provide reasonable visualizations of the often lognormal distributions at high fluorescence intensities.

The function becomes linear near zero, extends to negative data values and is symmetrical around zero, providing near-linear visualization appropriate for linear-normal distributions at low fluorescence intensities.

The transition between the linear to logarithmic regions is as smooth as possible to avoid introducing artifacts in the display.

As the linearization strength is increased to accommodate a wider range of linearized data values, the reasonably linear region of the data values grows faster than the size of the linearized region in the display. Thus the user has a visual indication that a greater degree of linearization is in use but display space is balanced between more linear and more logarithmic regions.

Representative Logicle Function Specifications

By considering the criteria, referred to above, and examining the behavior of a number of functions it was concluded that particular generalizations of the hyperbolic sin e function (sin h) that are also referred to herein as “Logicle functions” meet the criteria. The hyperbolic sin e function itself has the desirable properties of being essentially linear near zero, becoming exponential for large values (leading to a logarithmic display scale there) and making a very smooth transition between these regions (i.e., it is continuous in all derivatives), but it does not provide enough flexibility to meet the display needs encountered in flow cytometry or other applications.

Note, that in cytometry “logarithmic” axes are commonly labeled with values from the corresponding exponential function rather than with the logarithm itself, e.g. decade labels like 10, 100, 1000, not 1, 2, 3. The Logicle functions defined in the equations below are data value functions. Their inverses provide Logicle display functions in the same way that exponential scaling functions provide logarithmic data displays.

The hyperbolic sin e function itself is
S(x)=(e^{x}−e^{-x})/2 (Eq. 1)

This can be generalized to what are referred to as biexponential functions
S(x; a, b, c, d, f)=ae^{bx}−ce^{-dx}+f (Eq. 2)

Interpreting the condition of maximal linearity around data value zero to mean that the second derivative of the function should be zero there, a subset of biexponential functions were identified with this property and are also referred to herein as “Logicle scaling functions”. When used for visualization, the functions described herein allow the data to be rescaled as desired without changing the shape of the resulting graph.

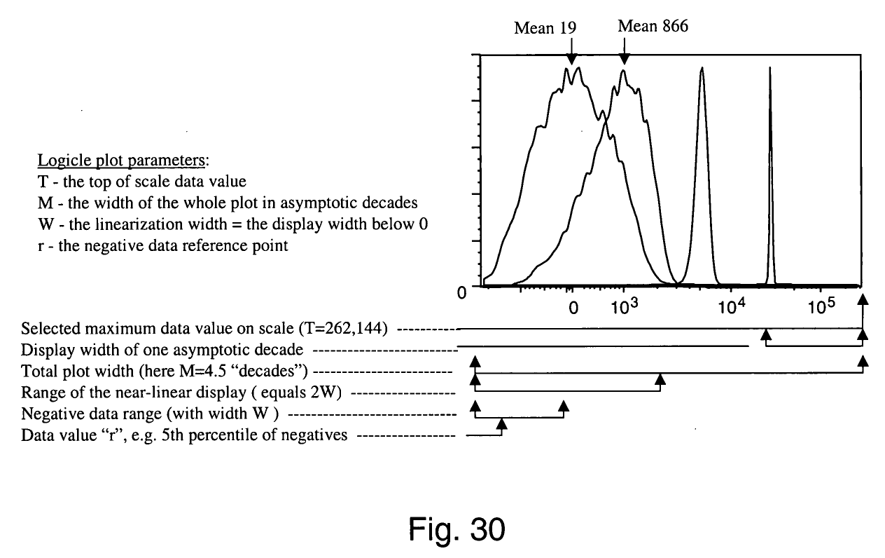

Besides the constraint specified above, there are four further choices that should be made to fix the five parameters in Eq. 2 (a, b, c, d and f) and thereby define a specific display. How these choices appear in an actual Logicle display is illustrated in FIG. 30. The parameters described below and in FIG. 30 are not simply a, b, c, d and f, but, once specified, they uniquely determine the function in Eq.2. The first choice is the maximum data value in the displayed scale. The second is the range of the display in relation to the width of high data value decades. If this is held constant among plots optimized to different data sets, the nearly logarithmic area at the upper end of each display will be essentially the same while the region near data zero is adjusted to optimize for different data sets. Although other widths are optionally utilized, a total plot width of 4.5 “decades” is usually a good choice for displaying, e.g., flow cytometry data.

The third choice is the strength and range of linearization around zero. The linear slope at zero (in, for example, data units per pixel or data units per mm in a printout) and the range of data in the nearly linear zone are determined by this selection. In displaying a particular data set the linearized range must be adequate to cover broad population distributions that do not display well on log scales. This, in particular, is the selection that is critical in matching displays to particular data sets and ensuring that the linearized zone covers the range of statistical spread in the data. If the transition toward log behavior occurs in too low data values, the artifacts seen in logarithmic display will not be suppressed.

The fourth choice is to specify the range of negative values to be included in the display (which also defines the position of the data zero in the plot). This range is typically great enough to avoid truncating populations of interest. In practice, it is sometimes desirable to link the third and fourth choices so that the lowest negative data values in view correspond to the approximate edge of the linearized zone. This is not surprising since negative data values occur only to the extent of statistical spreading.

Assuming that the top-of-scale value and the nominal “decade” width of the display have been selected, linking the third and fourth choices results in a family of functions with only one parameter to be adjusted to match the particular data set being displayed.

An expression for the Logicle scaling function that embodies the constraints and choices described above is
S(x;w)=Te^{-(m-w)}(e^{x-w}−p²e^{-(x-w)/p}+p²−1) for x>w (Eq. 3)
In Eq. 3:

T is the top of scale data value (e.g. 10,000 for common 4 decade data or 262,144 for an 18 bit data range).

w=2pln(p)/(p+1) is the width of the negative data range and the range of linearized data in natural log units. p is introduced for compactness in presenting the Logicle function, but it and w together represent a single adjustable parameter.

m is the breadth of the display in natural log units. For a 4.5 decade display range m=4.5ln(10)=10.36.

The display is defined for x in the range from 0 to m. Negative data values appear in the space from x=0 to x=w, and positive data values are plotted between x=w and x=m (where the top data value T occurs). The form shown as Eq. 3 is for the positive data zone where x>w. For the negative zone where x<w, symmetry is enforced by computing the Logicle function for the corresponding positive value (w−x) and changing the sign. The data zero at x=w is where the second derivative is zero, i.e., the most linear area.

In order to select an appropriate value for w to generate a good display for a particular data set, a reference value is obtained marking the low end of the distribution to be displayed. As described below, the data value is typically selected at the 5th percentile of all events that are below zero as this reference. Designating this value as “r”, w is computed as
w=(m−ln(T/r))/2 (Eq. 4)
Equations 3 and 4 can be re-written using base 10 representation in order to express the parameters in terms of “decades” of signal level or display:
S(X;W)=T*10^{-(M-W)}(10^{X-W}−p²*10^{-(X-W)/p}+p²−1) for X>W (Eq. 5)
In Eq. 3a:

W=2p log(p)/(p+1) is the width of the negative data range and the range of linearized data in “decades”.

M is the breadth of the display in “decades”. For a 4.5 decade display range M=4.5.

W is obtained from the negative range reference value “r” as
W=(M−log(T/r))/2 (Eq. 6)

FIG. 30 schematically illustrates the relationship between these parameters and the resulting Logicle display.

Specifying a logarithmic display uses two values corresponding to T and M, and the scaling near the upper end of a Logicle plot approximates that of a logarithmic display with the same values of T and M. The additional linearization width W adapts the scale to the characteristics of different data sets.

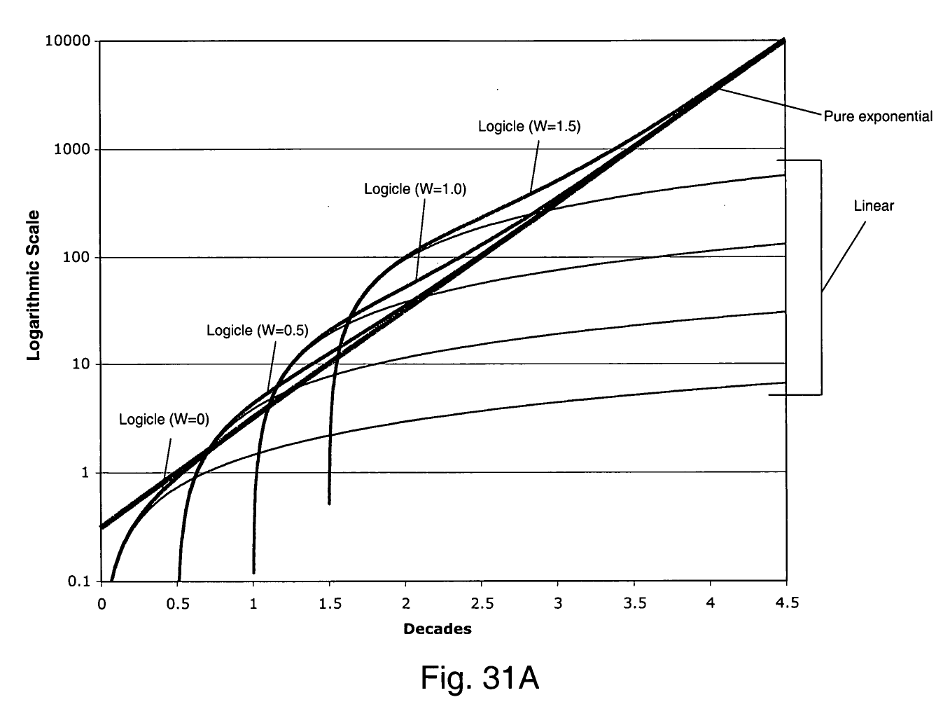

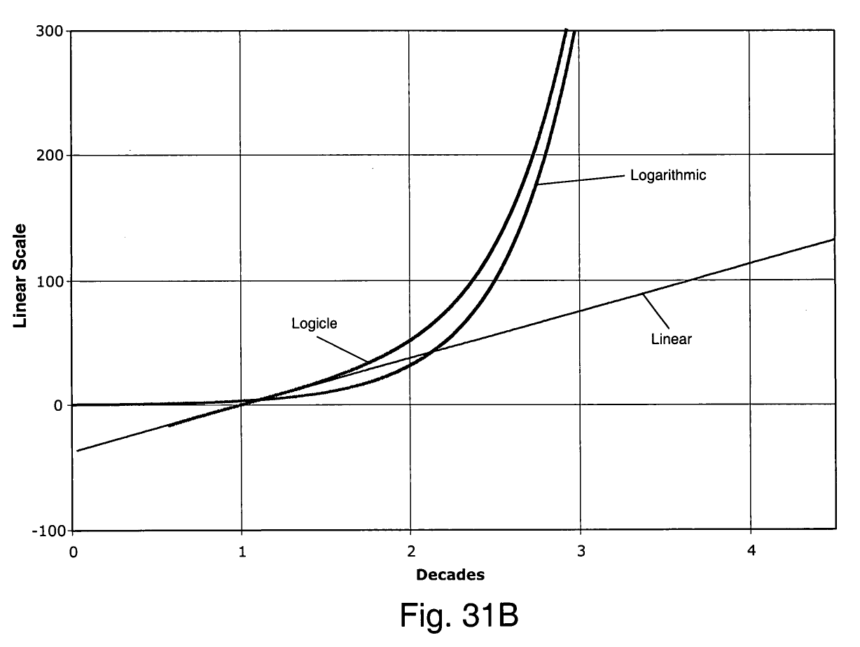

FIG. 31A illustrates several Logicle functions with W=0, W=0.5, W=1.0 and W=1.5. The display range covers 4.5 “decades”, and the signal level scale is logarithmic, so only the positive data values can be represented. The diagonal line is a pure exponential, i.e., the scaling function for a standard logarithmic display. The light curved lines are pure linear functions with zero crossings and slopes matched to the corresponding Logicle curves (heavy lines). Note that each Logicle curve closely follows its matched linear function at low signal values confirming good linearity in the region around data zero. At middle signal values, which vary depending on the value of W, the Logicle functions depart from linearity and move smoothly toward the exponential line. At high signal levels the Logicle curves become indistinguishable from the exponential line.

FIG. 31B shows the same data as in FIG. 31A, but for W=1.0 and with a linear signal level scale. The signal level scale is expanded (full scale is 100 rather than 10,000) to show in detail the matching of the Logicle and linear curves at low signal levels, the divergence of the Logicle curve at higher levels and the beginning of its approach to the exponential curve.

Representative Strategy for Selecting the Width Parameter

As described herein, proper estimates of dye signals using measurements on individual cells may be negative, but actual negative dye amounts are impossible. Therefore, any negative values present in the compensated data must be due to purely statistical effects. This is true despite the presence of essentially arbitrary positive staining distributions. Thus, for a population with near zero mean and significant statistical spread, the most negative values indicate the necessary range of the negative part of the scale, and they also indicate the range of linearization needed to ensure that the population will be displayed in a compact and unimodal form. The positive part of the population is less helpful since it may overlap other populations in the data set and not provide a clear upper end with which to define a suitable range for linearization.

A simple strategy of choosing the fifth percentile of the negative data values (or of data values below the mean or median of compensated unstained cells) to set this scale seems to work well and combines adequate sensitivity to extreme values with reasonable sampling stability. Using this strategy, the visible negative data range extends somewhat below the 5th percentile of negatives reference data value so that almost all the negative data (out to roughly 1.5 times the negative reference data value) is actually seen in the plot.

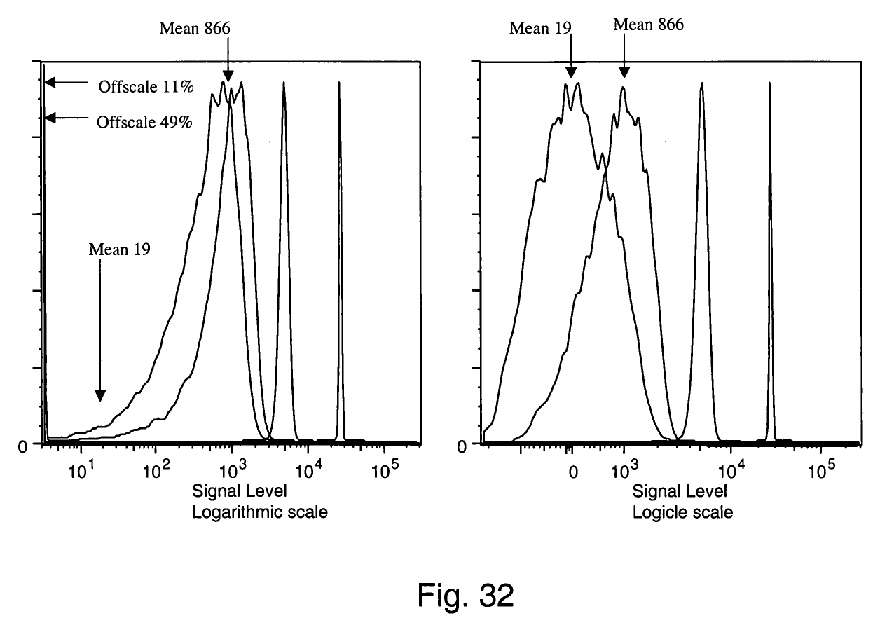

In cases where no negative data values occur or the negative values are all close to zero our experience indicates that a minimal Logicle scale sufficient to linearize data in the range of cell autofluorescences provides a more readily interpreted view of the data than does a purely logarithmic scale (see, for example, the horizontal PE-A dimension in FIG. 32).

In some data sets with few negative data values there may be some aberrant events yielding extreme negative values. In that case the 5th percentile of negatives value may lead to a value of W too high for optimal display of the main data set. Gating out the unrepresentative negative data points and reapplying the automatic scale selection to the gated data normally cures this problem.

In order to achieve consistency in the data display when analyzing experiments that include a number of samples to be compared, it is appropriate to fix the Logicle scale (for each dimension) based on the most extreme sample present (usually one with the maximum number of labels in use) and use these fixed scales to analyze all similarly stained samples in the experiment. Certain implementations base the scale selection on a single user-specified (gated) data set. A simple and probably desirable variant of this method operates on a group of data sets designated to be analyzed together. The Logicle width parameter would be evaluated for each dimension in each data set, and the largest resulting width in each dimension would be selected for the common displays. In general, when there are multiple populations in a single sample or multiple samples to be viewed on the same display scale, the population or sample with the greatest negative extent should drive the selection of W.

In some embodiments, the method chosen for defining the negative end of the display scale in relation to the linearization width makes it possible to evaluate the appropriateness of a particular scaling for a specific data set by examining the negative data region. If a substantial fraction of the negative data values pile up at the low end of the scale, the value of W is too low to properly display this data, and a higher value of W should be used. If there is a lot of empty negative data space below the lowest population of interest, that population is more compressed than necessary. The population will be properly compact and unimodal, but it would be advantageous to lower W and obtain a more expanded view.

The Effective Dynamic Range of a Logicle Display

A precise expression for the range of variation in scale across a Logicle plot can be given in a form analogous to the “dynamic range” of a logarithmic plot. An ordinary logarithmic scale is often characterized by the number of “decades”, i.e., by the common logarithm of the ratio of the maximum to the minimum data values. Clearly, with Logicle scales that extend through zero such a formula cannot work. However, if one considers the variation in the number of data units corresponding to a given width on the display we get a relevant and useful ratio corresponding to the range of expansion/compression of the data across the plot. Mathematically, this is the ratio of the highest and lowest values of the slope or derivative of the scale function within the plot. For an ordinary logarithmic scale this method yields exactly the same results as the usual procedure, i.e., the common logarithm of this ratio of slopes is the same as the number of decades as defined above. For a Logicle scale the ratio of maximum to minimum derivatives (at the top of scale and data zero, respectively) varies as a function of the linearization width W.

Working from the expression in Equation 3, the derivative is
S′(x;w)=Te^{-(m-w)}(e^{x-w}+pe^{-(x-w)/p)} for x>w (Eq. 7)

The effective dynamic range discussed above is S′(m;w)/S′(w;w), i.e., the ratio of derivatives at x=m and x=w.

For the Logicle curves illustrated in FIG. 30 with M=4.5 decades, the effective dynamic ranges are 4.2, 3.5, 2.8 and 2.1 decades for width values W=0.0, 0.5, 1.0 and 1.5, respectively. (The dynamic range of the logarithmic plot with comparable scaling in the upper range would be 4.5 decades.)

Illustrations and Interpretation of Logicle Displays

FIG. 32 shows a comparison of logarithmic and Logicle displays of four signal level distributions, which have different means but the same real widths. Note that the two higher level curves look essentially the same in the two displays since they occur at signal levels where the Logicle scale is nearly logarithmic. However, the lowest curve is shown very differently in the two graphs. Note that in the Logicle plot the mean data value occurs at the visual center of the peak and that very few data events fall at the low edge of the scale. In contrast the logarithmic display for this data set fails to convey an accurate view of the data in that the mean of the data appears in a highly counter-intuitive location far from the apparent peak of the plot. Also, of course, the 49% of very low and negative data values are piled up in an uninterpretable spike at the left edge of the display. This kind of behavior constitutes what may be referred to as a “log artifact” or, more colorfully, the “valley of death”. The second curve from the bottom is intermediate in that it is well represented in the Logicle display but shows a moderate amount of “log artifact” in the logarithmic display.

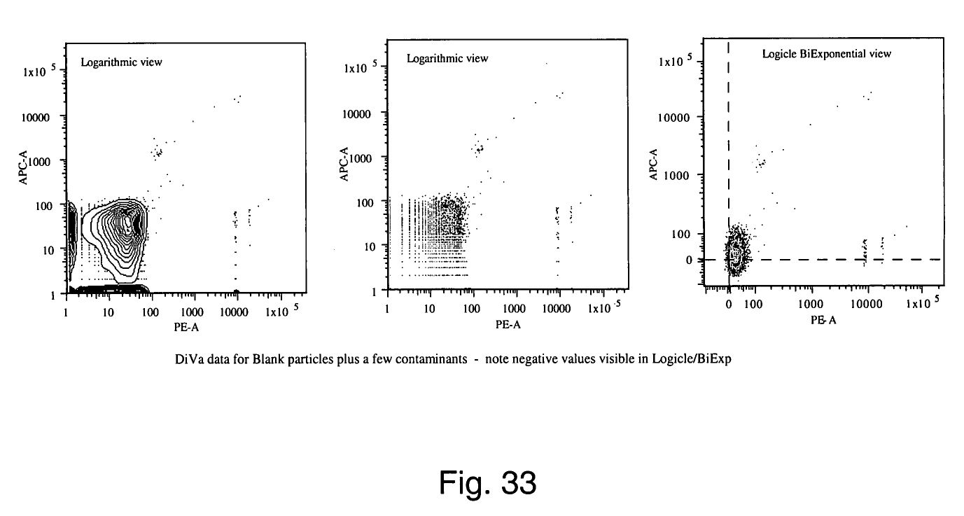

FIG. 33 illustrates the value of Logicle display in the analysis of data acquired in high resolution linear data systems. Here blank (undyed) particles from the Spherotech Rainbow series were measured on a FACSVantage DiVa system which produces integer floating point data with values up to 2ˆ18 or 262,144 and may include (background subtracted) data values below zero. The maximal range log displays (1 to 262,144) show “picket fencing” in the low region where there are more display pixels than actual data values. The pileup of lowest and negative data at the low margins of the logarithmic color dot plot is almost invisible while the pileup contours in the logarithmic contour plot make it look like there may be separate populations there. In contrast the Logicle display of the same data set shows a well-behaved two-dimensional peak in which only a few data values are below zero in the PE-A dimension while a large minority of the APC-A data values are below zero.

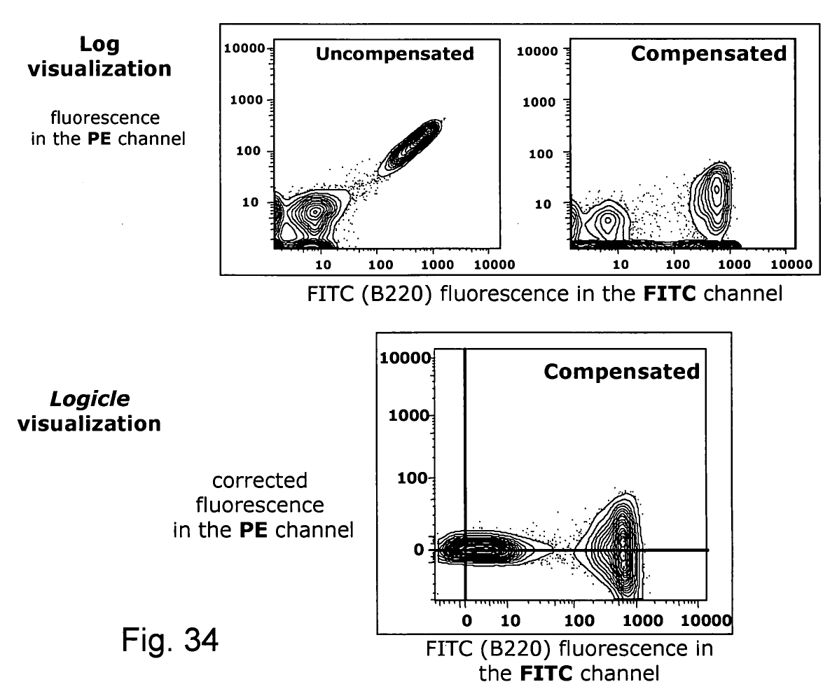

FIG. 34 illustrates the value of Logicle displays for intuitive and accurate interpretation of fluorescence compensated data. Data from an FITC-stained compensation control sample is shown uncompensated vs PE in the left panel. Computed compensation based partly on this sample itself leads to the logarithmic display in the middle panel. In the vertical compensated PE dimension the centers of the FITC low and high populations should be the same since neither carries any actual PE label. In the display, however, it looks like the FITC high population has higher net PE signal than the FITC low population. This is another manifestation of the “log artifact”. In fact, the PE dimension medians of the two populations are equal. This situation is represented clearly and correctly in the Logicle display at the right. The plot confirms that the centers of the two populations are aligned and near zero in the PE dimension. It is obvious that the FITC high population has greater spread in the PE dimension and that the threshold amount of real PE needed for identification of PE positive cells will be greater on the FITC high population than on the FITC low population.

Note, that the low area Logicle scales for the FITC and PE dimensions are different as indicated by the different displacements of the data zero from the low end of the display scales.

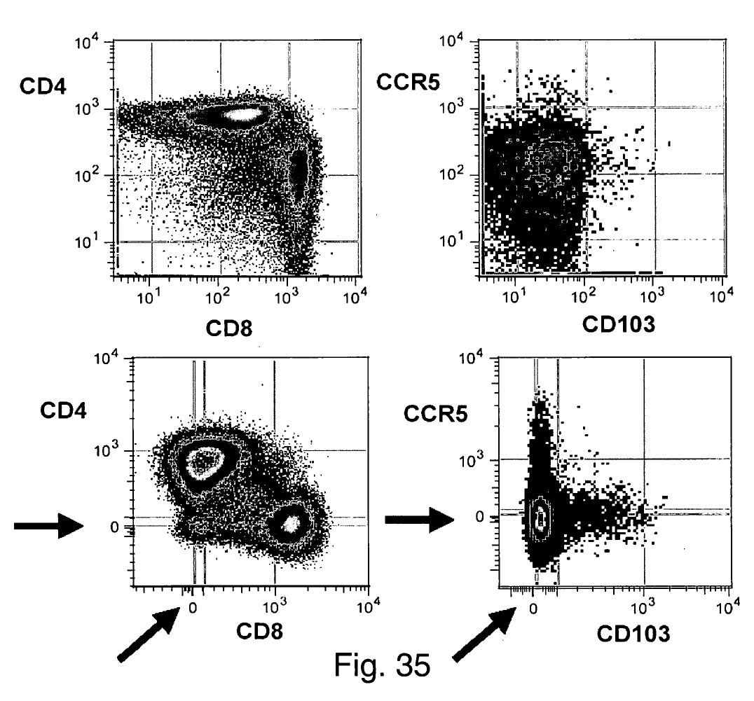

FIG. 35 shows the benefit of Logical displays in facilitating correct interpretation of multicolor compensated cell staining data. The seriously unsymmetrical views of cell populations and the confusing and unintuitive pileup of offscale data seen in the logarithmic displays are avoided in the Logicle displays.

Additional Benefits of Logicle Methods

One of the benefits of the full range Logicle display of fluorescence compensated data is in quality control and in correcting errors and avoiding erroneous interpretations. Since negative data values should be generated purely by statistical processes producing more-or-less normal distributions, data distributions in the negative zone should reflect this and not include peaks or other additional structure. Any such structure points to a problem in the data itself or in the data processing, which should be corrected before proceeding with the analysis. In particular, errors in defining the compensation matrix or applying the wrong matrix for the data will frequently produce clear visual artifacts in the negative data range.

Logicle coding could provide a compact way to store and transfer high dynamic range data of the types appropriate for Logicle display while retaining appropriate resolution over the whole data range. For example, recent instruments from BDBiosciences produce data values from 2¹⁸ down through zero to negative values presented as 32 bit real numbers. Logicle coding at 10-12 bits could retain all the relevant resolution in most data acquired on such instruments.

The effects of certain Logicle display embodiments on the quality of data interpretation and accuracy of statistical results also include:

1. Logicle display per se has no effect on statistical results since these are computed on the underlying data—not on the position of displayed events in plots.

2. Similarly, use of Logicle displays cannot change the overlap (or lack thereof) of different cell populations.

3. In many cases use of Logicle transformation improves the validity of statistical results compared to data analysis software which truncates low and negative values outside displayed log or linear scale ranges and therefore cannot compute correct statistics for populations including such data values.

4. Logicle displays help to confirm correct compensation in that the visual centers of positive and negative populations in single stain compensation controls line up when compensation is correct. This is not true in logarithmic displays.

5. Logicle displays typically lead to better selection of population boundaries (gates) and therefore improve validity of results. Logarithmic displays distort broad low mean populations to give a peak above the true center of the distribution and pileup of low to negative events at the scale minimum (baseline). This can lead to improper or at least suboptimal gate boundary selection. Logicle displays avoid this tendency by being nearly linear in the region near zero.

6. Since Logicle scales go smoothly from linear to logarithmic, they do not introduce artifacts that might obscure real distinctions between populations or give the impression of population distinctions that are not real.

7. Logicle transformed data is generally more suitable than plain log or linear scaling for automated analysis, such as peak finding and cluster analysis since local distortions and edge pileups are avoided or at least minimized.

8. The methods described herein for automatically selecting the Logicle width parameter to match particular data generally work well.

The Logicle scaling functions and Logicle display methods provide visualizations of flow cytometric and other types of data that are readily interpreted by viewers and that convey full and accurate information regarding the underlying distributions of the date and patterns of expression.

Alternative Approaches

A number of other approaches for improved methods to display flow cytometry data have been suggested. However, none fulfill all the criteria that are specified above. Also, none of the other proposals for alternative data displays have adequately addressed the issue of how to choose the scale parameter(s) optimally to match particular data. Certain approaches describe factors involved in making choices among so-called “Hyperlog functions”, but only recommend a generic scale choice rather than optimization to particular data. “Hyperlog functions” are also described in, e.g., Bagwell Hyperlog poster ISAC 2004 Cytometry Part A, Volume 59A, Number 1, May 2004, Addendum 122531, “Hyperlog—an alternative display transform for cytometry data,” C. Bruce Bagwell, which is incorporated by reference.

One method includes adding a constant to all data values, thus making all or nearly all of the negative values positive and then taking the logarithm. While this approach mitigates the distortions of populations with high variance and small mean that occur in logarithmic displays, it still produces the “log artifact”. It also does not have good linearity in the near zero region.

Another approach is to simply pick a transition point and use the logarithm for higher data values and a linear scale for smaller values. If the splice is made so that the resulting function is smooth, i.e., continuous in the first derivative so as to minimize distortion of distributions at this boundary, then the function is completely determined by the choice of splice point. However, the derivative matching requirement in a linear-log splice leads to functions with too little flexibility or adjustability to meet the criteria referred to above. Splice functions that do not match at least the first derivative at the splice tend to generate significant artifacts in the display.

One application area where functions close to linear around zero and logarithmic for high data values have been evaluated is in coding and compression of audio signals where the process is called “companding”. Such audio is of course bipolar so negative values must be handled, and human hearing has a more-or-less logarithmic response to high signal values, so recording such values to high resolution is not important. There are two versions in use. The American one is the same as the offset log described above. The European version uses the log-linear splice approach also discussed above. These techniques, as defined, are not flexible enough to deal adequately with flow cytometry or other types of data.

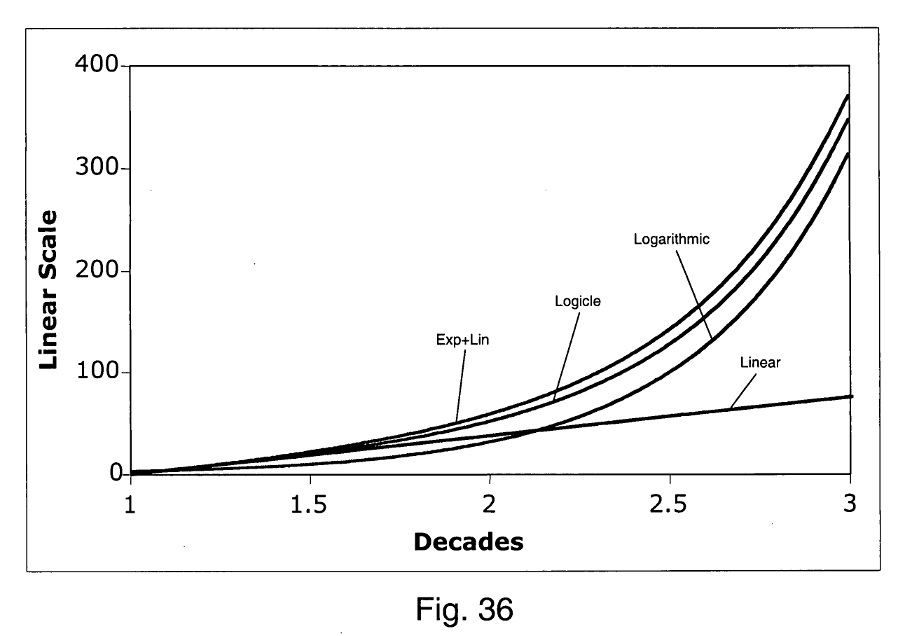

Another approach combines the linear and logarithmic properties by simply adding together a linear function, an exponential function and a constant and then using the inverse function as a scale. This functional form corresponds to the “Hyperlog” functions referred to above. In regions where the exponential term is large, the linear term is essentially irrelevant and, conversely, when the exponential term is small, the linear term dominates. This turns out to closely approximate the behavior of the Logicle functions, and a version similar to any given Logicle function can be obtained by replacing the e^{-x} term in the Logicle function in Eq. 3 with a truncated power series expansion. The expansion is e^{-x}=1−x+x²/2!−x³/3!+ . . . , so in Eq. 3 one can replace e^{-(x-w)/p} with 1−(x−w)/p yielding
S₁(x;w)=Te^{-(m-w)}(e^{x-w}−p²(1−(x−w)/p)+p²−1)
or S₁(x;w)=Te^{-(m-w)}(e^{x-w}+p(x−w)−1) for x>w (Eq. 8)
FIG. 36 compares this function with the corresponding log and Logicle functions. At x=w it has the same data value of zero and the same slope as the corresponding Logicle function. However, it does not fulfill the criterion stated above that the second derivative should be zero at the data zero so that near zero it departs from linearity more quickly than the corresponding Logicle function. Also, at the high end it approaches true log more slowly than the corresponding Logicle function.

### Web Site Embodiment

The methods of this invention can be implemented in a localized or distributed computing environment. For example, in one embodiment featuring a localized computing environment, a flow cytometry system is operably linked to a computational device equipped with user input and output features. In a distributed environment, the methods can be implemented on a single computer, a computer with multiple processes or, alternatively, on multiple computers. The computers can be linked, e.g., through a shared bus, but more commonly, the computer(s) are nodes on a network. The network can be generalized or dedicated, at a local level or distributed over a wide geographic area. In certain embodiments, the computers are components of an intra-net or an internet.

In such use, typically, a client (e.g., a scientist, a patient, practitioner, provider, or the like) executes a Web browser and is linked to a server computer executing a Web server. The Web browser is, for example, a program such as IBM's Web Explorer, Internet explorer, NetScape or Mosaic, or the like. The Web server is typically, but not necessarily, a program such as IBM's HTTP Daemon or other WWW daemon (e.g., LINUX-based forms of the program). The client computer is bi-directionally coupled with the server computer over a line or via a wireless system. In turn, the server computer is bi-directionally coupled with a website (server hosting the website) providing access to software implementing the methods of this invention. A user of a client connected to the Intranet or Internet may cause the client to request resources that are part of the web site(s) hosting the application(s) providing an implementation of the methods of this invention. Server program(s) then process the request to return the specified resources (assuming they are currently available). A standard naming convention has been adopted, known as a Uniform Resource Locator (“URL”). This convention encompasses several types of location names, presently including subclasses such as Hypertext Transport Protocol (“http”), File Transport Protocol (“ftp”), gopher, and Wide Area Information Service (“WAIS”). When a resource is downloaded, it may include the URLs of additional resources. Thus, the user of the client can easily learn of the existence of new resources that he or she had not specifically requested.

Methods of implementing Intranet and/or Intranet embodiments of computational and/or data access processes are well known to those of skill in the art and are documented, e.g., in ACM Press, pp. 383-392; ISO-ANSI, Working Draft, “Information Technology-Database Language SQL”, Jim Melton, Editor, International Organization for Standardization and American National Standards Institute, July 1992; ISO Working Draft, “Database Language SQL-Part 2:Foundation (SQL/Foundation)”, CD9075-2:199.chi.SQL, Sep. 11, 1997; and Cluer et al. (1992) A General Framework for the Optimization of Object-Oriented Queries, Proc SIGMOD International Conference on Management of Data, San Diego, Calif., Jun. 2-5, 1992, SIGMOD Record, vol. 21, Issue 2, June, 1992; Stonebraker, M., Editor. Other resources are available, e.g., from Microsoft, IBM, Sun and other software development companies.

Example Web Interface for Accessing Data Over a Network

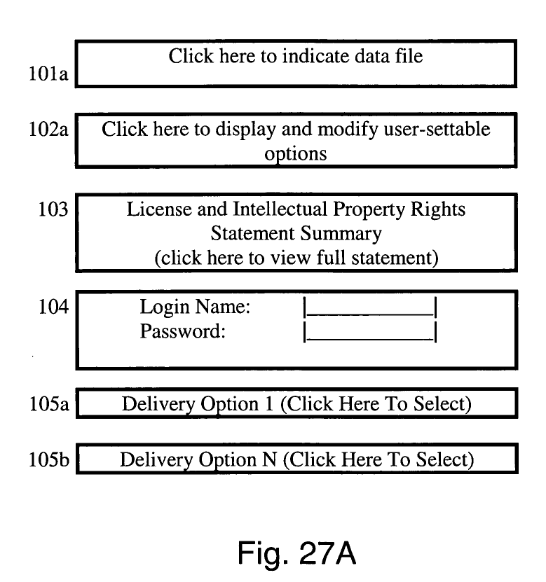

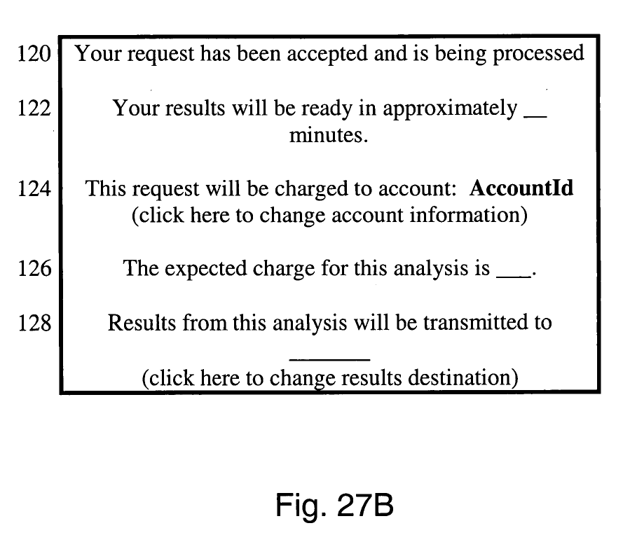

FIGS. 27A and B illustrate example interfaces for obtaining data analysis using a computer interface, possibly over a web page, according to specific embodiments of the present invention. FIG. 27A illustrates the display of a Web page or other computer interface for requesting statistical analysis. According to specific implementations and/or embodiments of the present invention, this example interface is sent from a server system to a client system when a user accessed the server system. This example Web page contains an input selection 101, allowing a user to specify input data. As will be understood in the art, each selection button can activate a set of cascading interface screens that allows a user to select from other available options or to browse for an input file. According to specific embodiments of the present invention, option selection 102 can also be provided, allowing a user to modify the user settable options discussed herein. A licensing information section 103 and user identification section 104 can also be included. One skilled in the art would appreciate that these various sections can be omitted or rearranged or adapted in various ways. The 104 section provides a conventional capability to enter account information or payment information or login information. (One skilled in the art would appreciate that a single Web page on the server system may contain all these sections but that various sections can be selectively included or excluded before sending the Web page to the client system.)

FIG. 27B illustrates the display of an interface confirming a request. The confirming Web page can contain various information pertaining to the order and can optionally include a confirmation indication allowing a user to make a final confirmation to proceed with the order. For particular systems or analysis, this page may also include warnings regarding use of proprietary data or methods and can include additional license terms, such as any rights retained by the owner of the server system in either the data.

### Embodiment in a Programmed Information Appliance

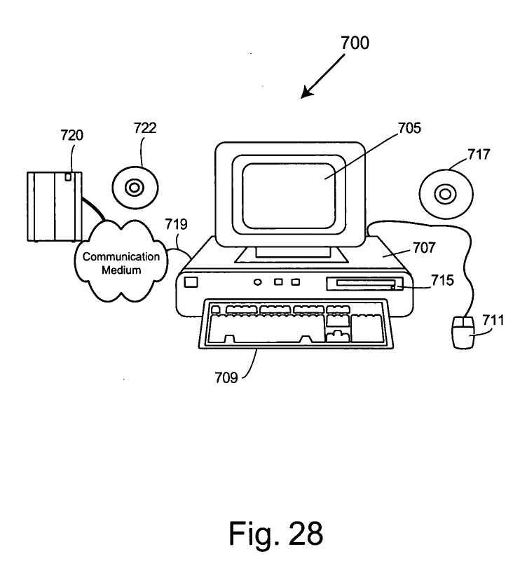

FIG. 28 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 28 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

Integrated Systems

Integrated systems, e.g., for performing FACS assays and data analysis, as well as for the compilation, storage and access of databases, typically include a digital computer with software including an instruction set as described herein, and, optionally, one or more of high-throughput sample control software, image analysis software, other data interpretation software, a robotic control armature for transferring solutions from a source to a destination (such as a detection device) operably linked to the digital computer, an input device (e.g., a computer keyboard) for entering subject data to the digital computer, or to control analysis operations or high throughput sample transfer by the robotic control armature. Optionally, the integrated system further comprises an image scanner for digitizing label signals from labeled assay components.

Readily available computational hardware resources using standard operating systems can be employed and modified according to the teachings provided herein, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX, or even Macintosh, Sun or PCs will suffice) for use in the integrated systems of the invention. Current art in software technology is adequate to allow implementation of the methods taught herein on a computer system. Thus, in specific embodiments, the present invention can comprise a set of logic instructions (either software, or hardware encoded instructions) for performing one or more of the methods as taught herein. For example, software for providing the described data and/or statistical analysis can be constructed by one of skill using a standard programming language such as Visual Basic, Fortran, Basic, Java, or the like. Such software can also be constructed utilizing a variety of statistical programming languages, toolkits, or libraries.

Various programming methods and algorithms, including genetic algorithms and neural networks, can be used to perform aspects of the data collection, correlation, and storage functions, as well as other desirable functions, as described herein. In addition, digital or analog systems such as digital or analog computer systems can control a variety of other functions such as the display and/or control of input and output files. Software for performing the statistical methods of the invention, such as programmed embodiments of the statistical methods described above, are also included in the computer systems of the invention. Alternatively, programming elements for performing such methods as principle component analysis (PCA) or least squares analysis can also be included in the digital system to identify relationships between data. Exemplary software for such methods is provided by Partek, Inc., St. Peter, Mo.; on the world wide web at partek.com. Optionally, the integrated systems of the invention include an automated workstation.

Automated and/or semi-automated methods for solid and liquid phase high-throughput sample preparation and evaluation are available, and supported by commercially available devices. For example, robotic devices for preparation of nucleic acids from bacterial colonies, e.g., to facilitate production and characterization of the libraries of candidate genes include, for example, an automated colony picker (e.g., the Q-bot, Genetix, U.K.) capable of identifying, sampling, and inoculating up to 10,000/4 hrs different clones into 96 well microtiter dishes. Alternatively, or in addition, robotic systems for liquid handling are available from a variety of sources, e.g., automated workstations like the automated synthesis apparatus developed by Takeda Chemical Industries, LTD. (Osaka, Japan) and many robotic systems utilizing robotic arms (Zymate II, Zymark Corporation, Hopkinton, Mass.; Orca, Beckman Coulter, Inc. (Fullerton, Calif.)) which mimic the manual operations performed by a scientist. Any of the above devices are suitable for use with the present invention, e.g., for high-throughput analysis of library components or subject leukocyte samples. The nature and implementation of modifications to these devices (if any) so that they can operate as discussed herein will be apparent to persons skilled in the relevant art.

A variety of commercially available peripheral equipment, including, e.g., flow cytometers and related optical and fluorescent detectors, and the like, and software are available for digitizing, storing and analyzing a digitized video or digitized optical or other assay results using a computer. Commerical Suppliers of flow cytometry instrumentation include Beckman Coulter, Inc. (Fullerton, Calif.) among many others.

### Example System Embodiment

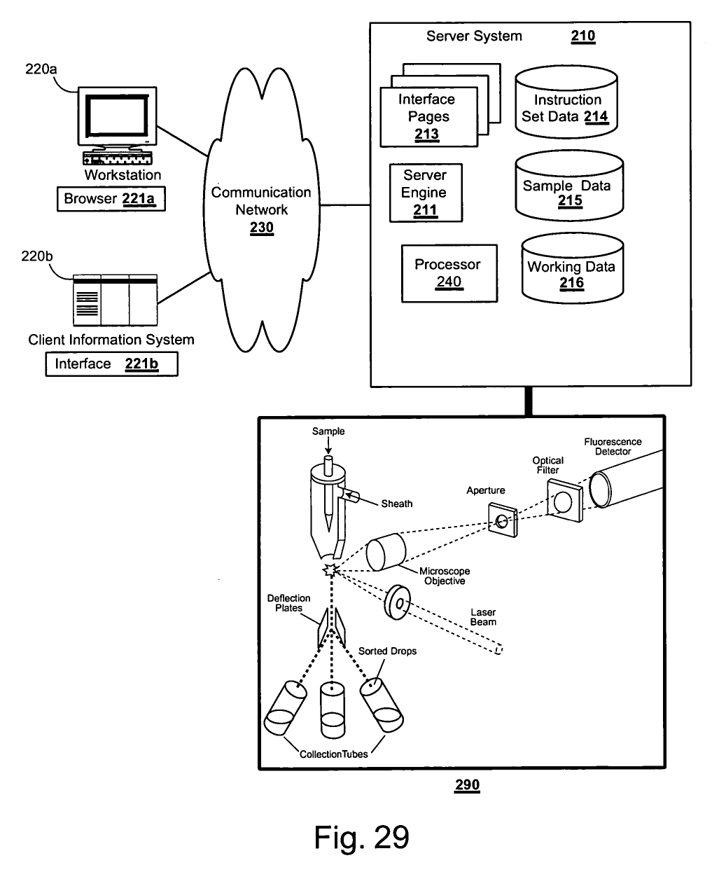

FIG. 29 is a block diagram illustrating an integrated system according to specific embodiments of the present invention. This particular example embodiment optionally supports providing statistical analysis over a network. The server system 210 includes a server engine 211, various interface pages 213, data storage 214 for storing instructions, data storage 215 for storing sample data, and data storage 216 for storing data generated by the computer system 210. According to specific embodiments of the invention, the server system further includes or is in communication with a processor 240 that further comprises one or more logic modules for performing one or more methods as described herein.

Optionally, one or more client systems may also comprise any combination of hardware and/or software that can interact with the server system. These systems may include digital workstation or computer systems (an example of which is shown as 220a) including a logic interface module (such as 221a) and/or various other systems or products through which data and requests can be communicated to a server system. These systems may also include laboratory-workstation-based systems (an example of which is shown as 220b) including a logic interface module (such as 221b) or various other systems or products through which data and requests can be communicated to a server system.

Optionally, the server computer 210 is in communication with or integrated with a flow cytometer system 290.

### Other Embodiments

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, etc.

Although the present invention has been described in terms of various specific embodiments, it is not intended that the invention be limited to these embodiments. Modification within the spirit of the invention will be apparent to those skilled in the art. In addition, various different actions can be used to effect the data analysis and/or display described herein. For example, a voice command may be spoken by the purchaser, a key may be depressed by the purchaser, a button on a client-side scientific device may be depressed by the user, or selection using any pointing device may be effected by the user.

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

What is claimed is:

1. A method of analyzing data, said method comprising:
scaling raw data using at least one scaling function that provides substantially linear transformations for data values proximal to zero and substantially logarithmic transformations for other data values to generate scaled data; and,
using said scaled data to identify portions of said raw data of interest.

2. The method of claim 1, wherein said raw data comprises high dynamic range data.

3. The method of claim 1, wherein said scaling and/or said using comprise using a computer.

4. The method of claim 1, wherein said scaling function transforms negative raw data values.

5. The method of claim 1, wherein a transition from linear to logarithmic scaling in said scaled data is substantially smooth.

6. The method of claim 1, wherein the second derivative of said scaling function is zero for a corresponding raw data value of zero.

7. The method of claim 1, wherein said scaling function comprises one or more optimization functions for viewing different raw data sets.

8. The method of claim 1, wherein said scaling function is substantially symmetrical proximal to a raw data value of zero.

9. The method of claim 1, wherein said raw data is derived through fluorescence compensation.

10. The method of claim 1, wherein said scaling comprises specifying at least one preliminary parameter such that other variables are constrained by one or more criteria of said scaling function, thereby defining at least one single variable transformation.

11. The method of claim 10, wherein said single variable transformation comprises a family of related transformations.

12. The method of claim 1, wherein said using comprises inputting said scaled data into at least one data analysis algorithm to identify said portions of said raw data of interest.

13. The method of claim 12, wherein said data analysis algorithm comprises automated data analysis software.

14. The method of claim 1, wherein said using comprises displaying said scaled data for a human viewer.

15. The method of claim 14, wherein said scaled data is displayed on a coordinate grid and said scaling function primarily depends on data in a single data dimension, thereby assuring that said coordinate grid is substantially rectilinear.

16. The method of claim 14, wherein display values increase in size more than corresponding display variables in linear regions of said scaled data as a family-generating variable is adjusted to increase a range of linearity.

17. The method of claim 14, wherein said scaling function comprises at least one generalized hyperbolic sin e function.

18. The method of claim 17, wherein said generalized hyperbolic sin e function is a form of V=Z(10^{n/m}−1−G²(10^{-n/mG}−1)), where V is a data value to be displayed at channel position n in a plot of said scaled data, m is the asymptotic channels per decade, and G is linearization strength.

19. The method of claim 17, wherein said generalized hyperbolic sin e function is a form of V=a(e^{x}−p²e^{-px}+p²1), where V is a data value to be plotted at display position x in a plot, a is a scaling factor, and p is linearization strength.

20. The method of claim 17, wherein said generalized hyperbolic sin e function is a form of S(x; a, b, c, d, So)=ae^{bx}−ce^{-dx}−So, for positive x and for negative x, a reflection of said positive x in a form of Sref(x; a, b, c, d, So)=(x/absx) S(absx; a, b, c, d, So), where absx is the absolute value of variable x.

21. A computer program product comprising a computer readable medium having one or more logic instructions for scaling raw data using at least one scaling function that provides substantially linear transformations for data values proximal to zero and substantially logarithmic transformations for other data values to generate scaled data.

22. The computer program product of claim 21, wherein said computer readable medium comprises one or more of: a CD-ROM, a floppy disk, a tape, a flash memory device or component, a system memory device or component, a hard drive, or a data signal embodied in a carrier wave.

23. A system for analyzing data, comprising:
(a) at least one detector; and,
(b) at least one computer operably connected to said detector, said computer having system software comprising one or more logic instructions for:
receiving raw data from said detector in said computer; and
scaling said raw data using at least one scaling function that provides substantially linear transformations for data values proximal to zero and substantially logarithmic transformations for other data values to generate scaled data.

24. The system of claim 23, wherein said system software further comprises one or more logic instructions for displaying said scaled data for a human viewer.

25. The system of claim 23, wherein said system software further comprises one or more logic instructions for analyzing said scaled data to identify portions of said raw data of interest.
